(19) United States
(12) Patent Application Publication
(10) Pub. No.: US 2022/0396593 A1
(43) Pub. Date: Dec. 15, 2022

(54) SYNTHESIS AND CHARACTERIZATION OF VANADIUM COMPLEXES

(71) Applicant: Colorado State University Research Foundation, Fort Collins, CO (US)

(72) Inventors: Debbie C. Crans, Fort Collins, CO (US); Heide Murakami, Fort Collins, CO (US); Kateryna Kostenkova, Fort Collins, CO (US)

(21) Appl. No.: 17/829,824

(22) Filed: Jun. 1, 2022

Related U.S. Application Data
(60) Provisional application No. 63/195,372, filed on Jun. 1, 2021.

(51) Int. Cl. C07F 9/00

(52) U.S. Cl. CPC C07F 9/005

(57) ABSTRACT

The present application relates to preparation methods and uses of vanadium complexes providing a consistent and stable preparation. More specifically, the present application relates to preparation of vanadium citrate salts, phosphate salts, or combinations thereof, characterization of the properties of such salts, and methods using the same.

### CROSS-REFERENCE TO RELATED APPLICATIONS

This application claims benefit of priority of U.S. Provisional Application No. 63/195,372, filed Jun. 1, 2021, which is hereby incorporated by reference in its entirety.

### FIELD

The present application is in the field of vanadium compounds. More specifically, the present application relates to methods of preparing and using compositions comprising vanadium salts and coordination complexes.

### BACKGROUND

It has recently been demonstrated that vanadyl sulfate, orthovanadate, and bismaltolatoxovanadate (BMOV) improve the replication and spread of oncolytic RNA viruses including vesicular stomatitis virus (VSV) and Measles while simultaneously enhancing immune stimulation (Selman et al, Mol Ther, 2018 and patent application PCT/CA2017/051176). Vanadium compounds have been historically studied for their anti-diabetic effects through hyperphosphorylation of the insulin receptor. While safe, derivatives such as bis(ethylato)oxovanadium(IV) (BEOV) have been evaluated and failed in human phase II clinical trials as antidiabetics. Vanadyl sulfate also has been tested clinically for the treatment of diabetes, but has yet to be approved as an anti-diabetic (phase III clinical trial registered completed NCT00561132).

Currently, oncolytic viruses (OVs) are mainly delivered intratumorally in patients. The first and as of yet only approved OV product in North America and Europe, Imlygic™ is administered in multiple superficial cancerous lesions in the context of advanced melanoma. Intravenous delivery of OVs still remains a hurdle as substantial amounts of virus are captured by sink organs like the liver and lungs, or neutralized by blood and immune cells, or hindered by poor vascularization and other tumor microenvironment associated barriers. Until such hurdles are overcome to allow for effective systemic delivery of OVs, there remains a significant need for methods and novel compositions for improving the effectiveness of intratumoral delivery of OVs, in such a way that would not be additionally onerous to clinicians that are administering these drugs.

Given their capacity to enhance viral spread and promote anti-tumor immunity simultaneously, the co-administration of vanadium-based molecules and OVs as a single injectable product would therefore be an attractive approach to enhance the spread and efficacy of OVs locally within the tumor. Co-administration is desirable over separate administrations of the vanadium compound and the OV because separate administrations require clinicians to administer the vanadium-based molecules by injecting all the vanadium molecules into the solid tumors of the patient, and then do the same with the OV, suitably in the same exact location. This is both cumbersome for the clinician and uncomfortable for the patient. Accordingly, it would be desirable to co-formulate a composition with both the OV and the vanadium-based molecule so that the clinician only needs to inject once per lesion and the tumor receives the OV and vanadium-based molecule in the same area.

While desirable from a practical and clinical standpoint, there are multiple challenges to co-formulating a composition with both the OV and the vanadium-based molecule. First, co-formulation requires that the compound and virus are biochemically compatible to permit admixing of virus and compound prior to intratumoral injection of the mixture. In the most extreme example, the compound and virus would be manufactured as a combination product requiring stability over several months to years. Hence the stability of the compounds is very important and is considered in this disclosure. Alternately, compound and virus can be produced and stored separately for admixing prior to injection, which in a clinical setting would nevertheless require stability for potentially several hours prior to injection. A second limitation, not mutually exclusive to the first, is dosing. Owing to the requirement for high concentrations of the vanadium compound in an ad-mixed virus co-formulation, there is a need for the vanadium compound to be more potent and not precipitate at the necessary high concentrations of both virus and compound.

As such, there is a need to provide improved compounds, stability and compositions that enhance oncolytic virus growth, spread, and/or cytotoxicity. Compounds and compositions that enhance virotherapy-induced anti-tumor immune responses and/or other therapy-induced responses that increase anti-cancer efficacy are also desired in the field.

Improved or alternative methods for preparing vanadium compounds are also desired for other uses.

### SUMMARY

In accordance with the purposes of the disclosed materials and methods, as embodied and broadly described herein, the disclosed subject matter, in one aspect, relates to methods for preparing and using compositions comprising one or more vanadium complexes wherein the one or more vanadium complexes are selected from a citrate salt of vanadium, a phosphate salt of vanadium or mixed salts thereof.

In some examples, the vanadium complex can include a vanadium(IV) citrate complex comprising vanadium(IV) and citrate prepared from mole ratios of 1:1 to 1:4, such as 1:1, 1:2, 1:3, or 1:4. In other examples, the prepared vanadium complex can include a vanadium(IV) phosphate complex comprising vanadium(IV) and phosphate in a mole ratio of 1:1 to 1:4, such as 1:1, 1:2, 1:3, or 1:4. Specific examples of the vanadium(IV) complex includes Na₄[V^{IV}₂O₂(C₆H₄O₇)₂] (CDOS139); K₂[V^{IV}₂O₄(C₆H₆O₇)₂]; K₄[V^{V}₂O₂(C₆H₄O₇)₂]; Na₃[(V^{IV}O)₂(C₆H₄O₇)(C₆H₅O₇)] (CDOS136); (K₃[(V^{IV}O)₂(C₆H₄O₇)(C₆H₅O₇)]); (NH₄)₄[V₂O₂(C₆H₄O₇)₂]; or [(V^{IV}O)₂(HPO₄)₂] (or Na₂[(V^{IV}O)₂(PO₄)₂]; CDOS137), wherein each complex optionally has one or more water hydrate.

In one aspect of the present disclosure, a method for preparing a composition comprising a vanadium(IV) complex is provided. The method for preparing the composition comprising the vanadium(IV) complex can include reacting a mixture comprising an aqueous solution of vanadyl(IV) sulfate (VOSO₄) and a buffer selected from a citrate buffer or a phosphate buffer, wherein the mixture has a mole ratio of VOSO₄ to citrate or phosphate of 1:0.5 to 1:10, and wherein the reaction is carried out at a pH of 9 or less, 7.5 or less, or from 6 to 7.5. When a citrate buffer is used in the reaction, the citrate buffer can comprise of citric acid and sodium citrate (or other metal ion salt). When a phosphate buffer is used in the reaction, the phosphate buffer can comprise of monobasic and dibasic sodium phosphate (or other metal ion salt). The pH of the buffer can be from 5.5 to 7.5, or from 6 to 7.

In another aspect of the present disclosure, a method for preparing a composition comprising a vanadium(IV) complex, the method comprising of reacting a mixture comprising an aqueous solution of vanadyl(IV) sulfate (VOSO₄) and citric acid or phosphoric acid, wherein the mixture has a mole ratio of VOSO₄ to citric acid or phosphoric acid of 1:0.5 to 1:10, and wherein the reaction is carried out at a pH of 7.5 or less, 5.5 or less, or from 4 to 5.5, is provided.

In the reaction mixture of the methods disclosed herein, the buffer, citric acid, or phosphoric acid can be present at a concentration of 1.5 M or less, such as 0.02 M to 1.2 M. In said mixture, the vanadyl(IV) sulfate can be present at a concentration of 1.5 M or less, such as 0.02 M to 1.2 M. In some embodiments, the mole ratio of VOSO₄ to citrate, phosphate, citric acid or phosphoric acid in the mixture can be 1:1 to 1:10, 1:1 to 1:5, or 1:1 to 1:4. The buffer, citric acid, or phosphoric acid is preferably added incrementally to the mixture.

The methods for preparing a composition comprising of a vanadium (IV) complex can further comprise heating the mixture to a temperature of 70° C. or less, such as from 40° C. to 60° C. At the end of the reaction, a polar organic solvent can be added to the mixture to induce crystallization of the vanadium(IV) complex. For example, methanol, isopropanol, acetone, ethyl acetate, ether, acetonitrile, or a combination thereof can be added to induce crystallization.

Generally, the reaction provides a yield for the vanadium(IV) complex of at least 50% by weight, or at least 70% by weight. The composition can comprise at least 30% by mass vanadium(IV) complex.

In some aspects of the present disclosure, a method for preparing a composition comprising a vanadium(V) complex is provided. In some examples, the prepared vanadium complex can include a vanadium(V) citrate complex prepared from vanadium(V) and citrate in a mole ratio of 1:1 to 1:4, such as 1:1, 1:2, 1:3, or 1:4, or the mole ratio can range from any of the minimum values described above to any of the maximum values described above.

Specific examples of the vanadium(V) citrate complex includes Na₆[(V^{V}₂O₂(O₂)₂(C₆H₄O₇)₂](CDOS140); Na₄[(V^{V}O₂)(C₆H₅O₇)]₂ (CDOS141); K₂[V^{V}₂O₄(C₆H₆O₇)₂], K₄[V^{V}₂O₄(C₆H₅O₇)₂] or (M⁺)₄[V^{V}₂O₄(C₆H₅O₇)₂], (NH₄)₆[V^{V}₂O₄(C₆H₄O₇)₂], K₃[(V^{V}O₂)₂(C₆H₆O₇)(C₆H₅O₇)], wherein each complex optionally has one or more water hydrates.

The method for preparing a composition comprising vanadium(V) citrate complex can include reacting in a mixture an aqueous solution of a metavanadate (VO₃³⁻) or orthovanadate (VO₄³⁻) compound and a citrate compound selected from citric acid, a citrate salt, a citrate buffer, or a combination thereof; wherein the metavanadate or orthovanadate compound and the citrate compound are prepared from solutions with mole ratios of 1:0.5 to 1:10, and wherein the reaction is carried out at a pH of 9 or less, 7.5 or less, or from 6 to 7.5. In some examples, the metavanadate compound is reacted with a mixture of citric acid and citrate salt.

In other examples, the metavanadate or orthovanadate compound is reacted with the citrate buffer.

In the reaction mixture, the citrate compound can be present at a concentration of 1.5 M or less, such as 0.05 M to 1.2 M. In the said mixture, the metavanadate or orthovanadate compound can be present at a concentration of 1.5 M or less, such as 0.02 M to 1.2 M. The mole ratio of metavanadate or orthovanadate compound to citrate compound in solution can be 1:1 to 1:10, 1:1 to 1:5, or 1:1 to 1:4. The buffer or citric acid is preferably added incrementally to the mixture.

The methods for preparing a composition comprising a vanadium (V) citrate complex can further comprise heating the mixture to a temperature of 70° C. or less, such as from 40° C. to 60° C. At the end of the reaction, a polar organic solvent can be added to the mixture to induce crystallization of the vanadium (V) complex. For example, methanol, isopropanol, acetone, ethyl acetate, ether, acetonitrile, or a combination thereof can be added to induce crystallization. Generally, the reaction provides a yield for the vanadium (V) complex of at least 50% by weight, or at least 70% by weight. The composition can comprise at least 30% by mass vanadium (V) complex.

In a further aspect of the present disclosure, a method for preparing a composition comprising a vanadium(V) citrate complex is provided. In some examples, the prepared vanadium complex can include a vanadium(V) citrate complex prepared from solutions comprising vanadium(V) and citrate in a mole ratio of 1:1 to 1:4, such as 1:1, 1:2, 1:3, or 1:4. Specific examples of the vanadium(V) citrate complex includes Na₆[(V^{V}₂O₂(O₂)₂(C₆H₄O₇)₂](CDOS140); Na₄[(V^{V}O₂)(C₆H₅O₇)]₂ (CDOS141); K₂[V^{V}₂O₄(C₆H₆O₇)₂], K₄[V^{V}₂O₄(C₆H₅O₇)₂], (NH₄)₆[V^{V}₂O₄(C₆H₄O₇)₂], and K₃[(V^{V}O₂)₂(C₆H₆O₇)(C₆H₅O₇)], wherein each complex optionally has one or more water hydrate.

The method for preparing a composition comprising a vanadium(V) citrate complex can comprise adding citric acid to a basic solution of V₂O₅ compound and allowing the citric acid and V₂O₅ compound to react at a temperature of 60° C. or less and a pH of less than 8, or from 4.5 to 7.5, wherein the method produces vanadium(V) citrate complex at a concentration of 10 mM or greater, is provided. The reaction can be carried out at a pH of 5 to 6, in some examples.

The vanadium complexes prepared herein can be in the form of a solid. The solid vanadium complexes are soluble (or can dissolve) and form a solution at acidic pH values (pH less than 7, less than 6, or less than 5.5). In some instances, the vanadium complexes are soluble and form a solution at about neutral pH, such as from pH 6 to 8, or from pH 6.8 to 7.6. It has been determined that the vanadium complexes are stable in aqueous solutions, PBS or other cell culture media, or a combination thereof, as determined by NMR. For example, the vanadium complexes are stable in solutions having pH 6.8 to 7.6, as determined by NMR.

Uses of the vanadium complex obtained from the methods disclosed herein are further provided. The vanadium complexes can be used without further purification after the preparation methods disclosed herein. In some examples, the complexes can be used in the manufacture of a pharmaceutical composition, catalyst, or battery. The pharmaceutical composition can be used for the treatment of a cancer, neurological diseases, and/or diabetes, or as an adjuvant for virus-based vaccine, in a subject in need thereof.

### DESCRIPTION OF THE FIGURES

FIG. 1 includes images showing the color change of solutions as increasing amounts of citrate is added to vanadium sulfate during preparation of a vanadium(IV) citrate complex (left container) and VOSO₄ (right container), indicative of the complex formation.

FIG. 2 is an image showing solution vanadium(IV) citrate complex obtained from 1:2 ratio of VOSO₄-citrate (CDOS136).

FIG. 3 shows images of solutions of CDOS136 at different pH values; 0.1 M V(IV) citrate at pH 2.57, 3.02, 4.09, 5.00 and 6.27 FIG. 4 shows EPR spectra of solutions of CDOS136 (1:1 ratio of V(IV) and citrate) at different pH values. The EPR spectra were recorded of solutions at 0.1 M V(IV) citrate, pH 2.57, pH 3.02, pH 4.09, pH 5.00 and pH 6.27.

FIG. 5 is an image showing solution vanadium(IV) phosphate complex obtained from VOSO₄ and phosphate (CDOS137).

FIGS. 6A-6D are images showing 0.2 M VOSO₄ solution (a), a 10:1 ratio of 0.2 M VOSO₄ to a 0.2 M phosphate buffer (b), 0.1 M V(IV) phosphate at 0 h (c), and 0.1 M V(IV) phosphate at 24 h (d).

FIG. 7 shows the EPR spectrum of 0.1 M vanadium(IV):phosphate 1:1 complex

FIG. 8 is a schematic diagram showing pH-dependent interconversion of V(V)-citrate complexes K₄[V₂O₄(C₆H₅O₇)₂].5.6H₂O (1) (compound is blue) to K₂[V₂O₄(C₆H₆O₇)₂].4H₂O (2) (compound is yellow-green) in aqueous solution; the difference is protonation state on the citrate ligand.

FIGS. 9A-9D show stacked ¹H and ⁵¹V spectra that demonstrate the relative amounts of the vanadium(V) citrate complex and the free citrate ligand at 0 hours for non-heated (a and b) and heated (c and d) mixtures.

FIGS. 10A-10D are images of different protonate states for (Na₂[VO₂(C₆H₆O₇)]₂.2H₂O), CDOS140 which contains 2Na⁺, present is solution as pH changes for this system. A) Complex contains 4 H⁺; B) Complex contains 2H⁺; C) Complex contains 3H⁺ and D) Complex contains H⁺

FIG. 11 include ¹H NMR (D₂O with DSS reference, 400 MHz) and ⁵¹V NMR (D₂O, 105.2 MHz) spectra of CDOS140 (prepared from V₂O₅).

FIG. 12 includes a synthetic scheme of the vanadium(V) complex prepared at pH 7 from 1:4 vanadate to citrate molar ratio. The complex is shown containing 3 Na⁺ cations.

FIG. 13 includes a synthetic scheme of CDOS140 (when cation is Na⁺; CDOS150 when cation is K⁺) prepared from V₂O₅ with the complex shown containing 3 cations.

FIGS. 14A-14F show images of reaction mixture after dissolution of V₂O₅(FIG. 14A), reaction mixture after the reaction completion (FIG. 14B), the isolated product in (FIG. 14C) and (FIG. 14D). Two tables are included describing 1) changes in color of solutions in water beginning at pH 7.17 and following pH and color changes for 7 days (FIG. 14E) and 2) changes in color of solutions in phosphate buffered saline (PBS) buffer beginning at pH 7.17 and following pH and color changes for 7 days (FIG. 14F).

FIG. 15 shows FT-IR spectra of vanadium citrate complex.

FIG. 16 shows mass spectrum of CDOS140 prepared at large scale.

FIG. 17 shows the mass spectrum corresponding to Na₃[(V^{IV}O)₂(C₆H₄O₇)(C₆H₅O₇)], (CDOS136)

FIG. 18 shows the mass spectrum of CDOS155 prepared at large scale.

FIG. 19 shows ¹H (D₂O with DSS reference, 400 MHz) and ⁵¹V (D₂O, 105.2 MHz) spectra of vanadium citrate complex

FIG. 20 shows NMR characterization and images of solutions after dissolution of vanadium(V) complex in water and PBS as a function of time both with regard to NMR spectra and pH values

### DETAILED DESCRIPTION

The materials, compounds, compositions, and methods described herein may be understood more readily by reference to the following detailed description of specific aspects of the disclosed subject matter and the Examples included therein.

Before the present materials, compounds, compositions, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

Throughout the specification and claims the word “comprise” and other forms of the word, such as “comprising” and “comprises,” means including but not limited to, and is not intended to exclude, for example, other additives, components, integers, or steps.

The term “consisting” and its derivatives as used herein are intended to be closed terms that specify the presence of the stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

As used in the description and the appended claims, the singular forms “a,” “an,” and “the” include plural referents unless the context clearly dictates otherwise. Thus, for example, reference to “a composition” includes mixtures of two or more such compositions, reference to “the complex” includes mixtures of two or more such complexes, and the like.

In embodiments comprising an “additional” or “second” component, such as an additional or second compound, the second component as used herein is chemically different from the other components or first component. A “third” component is different from the other, first, and second components, and further enumerated or “additional” components are similarly different.

The term “and/or” as used herein means that the listed items are present, or used, individually or in combination. In effect, this term means that “one or more of” or “one or more” of the listed items is used or present. The term “and/or” with respect to enantiomers, prodrugs, salts and/or solvates thereof means that the compounds of the application exist as individual enantiomers, prodrugs, salts and hydrates, as well as a combination of, for example, a salt of a solvate of a compound of the application.

“Optional” or “optionally” means that the subsequently described event or circumstance can or cannot occur, and that the description includes instances where the event or circumstance occurs and instances where it does not.

Notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

Further, ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Unless stated otherwise, the term “about” means within 5% (e.g., within 2% or 1%) of the particular value modified by the term “about.”

As used herein, “treatment” refers to obtaining beneficial or desired clinical results. Beneficial or desired clinical results include, but are not limited to, any one or more of: alleviation of one or more symptoms (such as tumor growth or metastasis), diminishment of extent of cancer, stabilized (i.e., not worsening) state of cancer, preventing or delaying spread (e.g., metastasis) of the cancer, delaying occurrence or recurrence of cancer, delay or slowing of cancer progression, amelioration of the cancer state, and remission (whether partial or total).

The term “patient” or “subject” preferably refers to a human in need of treatment with an anti-cancer agent or treatment for any purpose, and more preferably a human in need of such a treatment to treat cancer, or a precancerous condition or lesion. However, the term “patient” or “subject” can also refer to non-human animals, preferably mammals such as dogs, cats, horses, cows, pigs, sheep and non-human primates, among others, that are in need of treatment with an anti-cancer agent or treatment.

As used herein, the term “composition” is intended to encompass a product comprising the specified ingredients in the specified amounts, as well as any product which results, directly or indirectly, from combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight component Y, X and Y are present at a weight ratio of 2:5, and are present in such ratio regardless of whether additional components are contained in the mixture.

A weight percent (wt. %) of a component, unless specifically stated to the contrary, is based on the total weight of the formulation or composition in which the component is included.

The term “vanadium compound of the application” or “vanadium compound of the present application” and the like as used herein refers to a phosphate or citrate salt of vanadium.

The term “citrate” as used herein refers to salts of citric acid. Citric acid has the following structure:

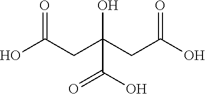 [SMILES: O=C(O)CC(O)(CC(=O)O)C(=O)O]

Citrate may present different protonation states depending on pH of the solution or methods of its preparation, and salts can be formed by replacing the acidic protons with one, two, three or four cations. A person skilled in the art would understand that vanadium can form a coordination bond with one, two, three or all four of the oxygen atoms in the OH groups of citric acid.

The term “phosphate” as used herein refers to salts of a phosphoric acid, most commonly the salts of orthophosphoric acid. Orthophosphoric acid has the following structure:

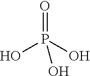

and salts can be formed by replacing the acidic protons with one, two or three cations. A person skilled in the art would understand that vanadium can form a coordination bond with at least one of the oxygen atoms in the OH groups of orthophosphoric acid.

The term “pharmaceutical composition of the application” or “pharmaceutical composition of the present application” and the like as used herein refers to a pharmaceutical composition comprising one or more vanadium compounds of the application.

The term “suitable” as used herein means that the selection of the particular composition or conditions would depend on the specific steps to be performed, the identity of the components to be transformed and/or the specific use for the compositions, but the selection would be well within the skill of a person trained in the art.

The present description refers to a number of chemical terms and abbreviations used by those skilled in the art. Nevertheless, definitions of selected terms are provided for clarity and consistency.

The term “vanadium compound” as used herein refers to compounds which include a vanadium transition metal core. The vanadium core can be in any oxidation state.

The term “subject” as used herein includes all members of the animal kingdom including mammals, and suitably refers to humans. Thus, the methods and uses of the present application are applicable to both human therapy and veterinary applications.

The term “solvate” as used herein means a compound, or a salt and/or prodrug of a compound, wherein molecules of a suitable solvent are incorporated in the crystal lattice. A suitable solvent is physiologically tolerable at the dosage administered.

The term “treating” or “treatment” as used herein and as is well understood in the art, means an approach for obtaining beneficial or desired results, including clinical results. Beneficial or desired clinical results can include, but are not limited to alleviation or amelioration of one or more symptoms or conditions, diminishment of extent of disease, stabilized (i.e. not worsening) state of disease, preventing spread of disease, delay or slowing of disease progression, amelioration or palliation of the disease state, diminishment of the reoccurrence of disease, and remission (whether partial or total), whether detectable or undetectable. “Treating” and “treatment” can also mean prolonging survival as compared to expected survival if not receiving treatment. “Treating” and “treatment” as used herein also include prophylactic treatment. For example, a subject with early cancer can be treated to prevent progression, or alternatively a subject in remission can be treated with a compound or composition of the application to prevent recurrence. Treatment methods comprise administering to a subject a therapeutically effective amount of one or more of the compounds of the application and optionally consist of a single administration, or alternatively comprise a series of administrations.

The term “prevention” or “prophylaxis”, or synonym thereto, as used herein refers to a reduction in the risk or probability of a patient becoming afflicted with a disease, disorder or condition, or manifesting a symptom associated with a disease, disorder or condition.

The term “administered” as used herein means administration of a therapeutically effective amount of a compound, or one or more compounds, or a composition of the application to a cell either in cell culture or in a subject.

As used herein, the term “effective amount” or “therapeutically effective amount” means an amount of a compound, or one or more compounds, of the application that is effective, at dosages and for periods of time necessary to achieve the desired result.

The term “cancer” as used herein refers to cellular-proliferative disease states.

As used herein, the term “effective amount” means an amount effective, at dosages and for periods of time, necessary to achieve a desired result.

The term “increase” as used herein refers to any detectable increase or enhancement in a function or characteristic in the presence of one or more test variable, compared to otherwise the same conditions except in the absence of the one or more test variable.

It is to be understood that the compounds provided herein may contain chiral centers. Such chiral centers may be of either the (R-) or (S-) configuration. The compounds provided herein may either be enantiomerically pure, or be diastereomeric or enantiomeric mixtures. It is to be understood that the chiral centers of the compounds provided herein may undergo epimerization in vivo. As such, one of skill in the art will recognize that administration of a compound in its (R-) form is equivalent, for compounds that undergo epimerization in vivo, to administration of the compound in its (S-) form.

The compounds disclosed herein can be prepared and/or administered as single enantiomers (enantiomerically pure and having an enantiomeric excess of >90%, preferably at least 97%, more preferably at least 99%), enantiomerically enriched (one of the enantiomers of a compound is present in excess compared to the other enantiomer), diastereomerically pure (having a diastereomeric p excess of >90%, preferably at least 97%, more preferably at least 99%), diastereomerically enriched (one of the diastereomers of a compound is present in excess compared to the other diastereomer), or as a racemic mixture (an equimolar mixture of two enantiomeric components).

As used herein, substantially pure means sufficiently homogeneous to appear free of readily detectable impurities as determined by standard methods of analysis, such as thin layer chromatography (TLC), nuclear magnetic resonance (NMR), gel electrophoresis, high performance liquid chromatography (HPLC) and mass spectrometry (MS), gas-chromatography mass spectrometry (GC-MS), and similar, used by those of skill in the art to assess such purity, or sufficiently pure such that further purification would not detectably alter the physical and chemical properties, such as enzymatic and biological activities, of the substance. Both traditional and modern methods for purification of the compounds to produce substantially chemically pure compounds are known to those of skill in the art. A substantially chemically pure compound may, however, be a mixture of stereoisomers.

Unless stated to the contrary, a formula with chemical bonds shown only as solid lines and not as wedges or dashed lines contemplates each possible isomer, e.g., each enantiomer, diastereomer, and meso compound, and a mixture of isomers, such as a racemic or scalemic mixture.

A “pharmaceutically acceptable” component is one that is suitable for use with humans and/or animals without undue adverse side effects (such as toxicity, irritation, and allergic response) commensurate with a reasonable benefit/risk ratio.

“Pharmaceutically acceptable salt” refers to a salt that is pharmaceutically acceptable and has the desired pharmacological properties. Such salts include those that may be formed where acidic protons present in the compounds are capable of reacting with inorganic or organic bases. Suitable inorganic salts include those formed with the alkali metals, e.g., sodium, potassium, magnesium, calcium, and aluminum. Suitable organic salts include those formed with organic bases such as the amine bases, e.g., ethanolamine, diethanolamine, triethanolamine, tromethamine, N-methylglucamine, and the like. Such salts also include acid addition salts formed with inorganic acids (e.g., hydrochloric and hydrobromic acids) and organic acids (e.g., acetic acid, citric acid, maleic acid, and the alkane- and arene-sulfonic acids such as methanesulfonic acid and benzenesulfonic acid). When two acidic groups are present, a pharmaceutically acceptable salt may be a mono-acid-mono-salt or a di-salt; similarly, where there are more than two acidic groups present, some or all of such groups can be converted into salts.

“Pharmaceutically acceptable excipient” refers to an excipient that is conventionally useful in preparing a pharmaceutical composition that is generally safe, non-toxic, and desirable, and includes excipients that are acceptable for veterinary use as well as for human pharmaceutical use. Such excipients can be solid, liquid, semisolid, or, in the case of an aerosol composition, gaseous.

A “pharmaceutically acceptable carrier” is a carrier, such as a solvent, suspending agent or vehicle, for delivering the disclosed compounds to the patient. The carrier can be liquid or solid and is selected with the planned manner of administration in mind. Liposomes are also a pharmaceutical carrier. As used herein, “carrier” includes any and all solvents, dispersion media, vehicles, coatings, diluents, antibacterial and antifungal agents, isotonic and absorption delaying agents, buffers, carrier solutions, suspensions, colloids, and the like. The use of such media and agents for pharmaceutical active substances is well known in the art. Except insofar as any conventional media or agent is incompatible with the active ingredient, its use in the therapeutic compositions is contemplated.

Pharmaceutical compositions disclosed herein may be in the form of pharmaceutically acceptable salts or prodrugs as generally described below. Pharmaceutically acceptable salts of the compounds include the acid addition and base salts thereof. Suitable acid addition salts are formed from acids which form non-toxic salts. Examples include the acetate, adipate, aspartate, benzoate, besylate, bicarbonate/carbonate, bisulfate/sulfate, borate, camsylate, citrate, cyclamate, edisylate, esylate, formate, fumarate, gluceptate, gluconate, glucuronate, hexafluorophosphate, hibenzate, hydrochloride/chloride, hydrobromide/bromide, hydroiodide/iodide, isethionate, lactate, malate, maleate, malonate, mesylate, methylsulfate, naphthylate, 2-napsylate, nicotinate, nitrate, orotate, oxalate, palmitate, pamoate, phosphate/hydrogen phosphate/dihydrogen phosphate, pyroglutamate, saccharate, stearate, succinate, tannate, tartrate, tosylate, trifluoroacetate and xinofoate salts. Suitable base salts are formed from bases that form non-toxic salts. Examples include the aluminium, arginine, benzathine, calcium, choline, diethylamine, diolamine, glycine, lysine, magnesium, meglumine, olamine, potassium, sodium, tromethamine and zinc salts. Hemisalts of acids and bases may also be formed, for example, hemisulfate and hemicalcium salts. For a review on suitable salts, see Handbook of Pharmaceutical Salts: Properties, Selection, and Use by Stahl and Wermuth (Wiley-VCH, 2002), incorporated herein by reference. Some preferred, but non-limiting examples of suitable pharmaceutically acceptable organic and/or inorganic acids are hydrochloric acid, hydrobromic acid, sulfuric acid, nitric acid, acetic acid and citric acid, as well as other pharmaceutically acceptable acids known per se (for which reference is made to the references referred to below). When the compounds of the disclosure contain an acidic group as well as a basic group, the compounds of the disclosure may also form internal salts, and such compounds are within the scope of the disclosure. When a compound of the disclosure contains a hydrogen-donating heteroatom (e.g., NH), the disclosure also covers salts and/or isomers formed by the transfer of the hydrogen atom to a basic group or atom within the molecule.

As used herein, the term “derivative” refers to a structurally similar compound that retains sufficient functional attributes of the identified analogue. The derivative may be structurally similar because it is lacking one or more atoms, substituted with one or more substituents, a salt, in different hydration/oxidation states, e.g., substituting a single or double bond, substituting a hydroxy group for a ketone, or because one or more atoms within the molecule are switched, such as, but not limited to, replacing an oxygen atom with a sulfur or nitrogen atom or replacing an amino group with a hydroxyl group or vice versa. Replacing a carbon with nitrogen in an aromatic ring is a contemplated derivative. The derivative may be a prodrug. Derivatives may be prepared by any variety of synthetic methods or appropriate adaptations presented in the chemical literature or as in synthetic or organic chemistry text books, such as those provide in March's Advanced Organic Chemistry: Reactions, Mechanisms, and Structure, Wiley, 6th Edition (2007) Michael B. Smith or Domino Reactions in Organic Synthesis, Wiley (2006) Lutz F. Tietze hereby incorporated by reference.

The term “therapeutically effective amount” as used herein means that amount of active compound or pharmaceutical agent that elicits the biological or medicinal response in a tissue, system, animal or human that is being sought by a researcher, veterinarian, medical doctor or other clinician. In reference to cancers or other unwanted cell proliferation, an effective amount comprises an amount sufficient to cause a tumor to shrink and/or to decrease the growth rate of the tumor (such as to suppress tumor growth) or to prevent or delay other unwanted cell proliferation. In some embodiments, an effective amount is an amount sufficient to delay development. In some embodiments, an effective amount is an amount sufficient to prevent or delay occurrence and/or recurrence. An effective amount can be administered in one or more doses. In the case of cancer, the effective amount of the drug or composition may: (i) reduce the number of cancer cells; (ii) reduce tumor size; (iii) inhibit, retard, slow to some extent and preferably stop cancer cell infiltration into peripheral organs; (iv) inhibit (i.e., slow to some extent and preferably stop) tumor metastasis; (v) inhibit tumor growth; (vi) prevent or delay occurrence and/or recurrence of tumor; and/or (vii) relieve to some extent one or more of the symptoms associated with the cancer.

Effective amounts of a compound or composition described herein for treating a mammalian subject can include about 0.1 to about 1000 mg/Kg of body weight of the subject/day, such as from about 1 to about 100 mg/Kg/day, especially from about 10 to about 100 mg/Kg/day. The doses can be acute or chronic. A broad range of disclosed composition dosages are believed to be both safe and effective.

Reference will now be made in detail to specific aspects of the disclosed materials, compounds, compositions, articles, and methods, examples of which are illustrated in the accompanying Examples.

Compounds

The present application includes methods for preparing and using compositions comprising one or more vanadium complexes wherein the one or more vanadium complexes are selected from a citrate salt of vanadium, a phosphate salt of vanadium or mixed salts thereof.

In some embodiments, the one or more vanadium complexes comprise vanadium(IV). In other embodiments, the one or more vanadium complexes comprise vanadium(V).

In some embodiments, the citrate and/or phosphate salts of vanadium comprise one or more pharmaceutically acceptable solvent molecules within their structure, accordingly the salts are in the form of solvates. In some embodiments, the solvent is water, accordingly the salts are in the form of hydrates. In some embodiments, the vanadium salt comprises a mixture of citrate and phosphate salts.

As described herein, there have been multiple challenges to co-formulate pharmaceutical compositions and vanadium-based compounds. Desirably, the vanadium complexes are soluble and stable in pharmacological solutions and at pharmacological pH. The vanadium complexes prepared herein can be in the form of a solid. The solid vanadium complexes are soluble (or can dissolve) and form a solution at acidic pH values (such as pH less than 7, less than 6, or less than 5.5) or at about neutral pH (such as pH 6 to 8, pH 6.5 to 7.5, or pH 6.8 to 7.6). It has been determined that the vanadium complexes are stable in aqueous solutions, PBS media, other cell culture media, or a combination thereof, as determined by NMR. For example, the vanadium complexes are stable in solutions having pH 6.8 to 7.6, as determined by NMR.

A First Method for Preparation of Vanadium(IV) Complexes

In one aspect of the present disclosure, a method for preparing a composition comprising a vanadium(IV) complex is provided. In some examples, the prepared vanadium complex can include a vanadium(IV) citrate complex comprising vanadium(IV) and citrate in a mole ratio of 1:1 to 1:4, such as 1:1, 1:2, 1:3, or 1:4. In other examples, the prepared vanadium complex can include a vanadium(IV) phosphate complex comprising vanadium(IV) and phosphate in a mole ratio of 1:1 to 1:4, such as 1:1, 1:2, 1:3, or 1:4. Specific examples of the vanadium (IV) complex include Na₄[V^{V}₂O₂(C₆H₄O₇)₂] (CDOS139); K₂[V^{IV}₂O₄(C₆H₆O₇)₂]; K₄[V^{IV}₂O₂(C₆H₄O₇)₂]; Na₃[(V^{IV}O)₂(C₆H₄O₇)(C₆H₅O₇)] (CDOS136); (K₃[(V^{IV}O)₂(C₆H₄O₇)(C₆H₅O₇)]); (NH₄)₄[V₂O₂(C₆H₄O₇)₂]; or [(V^{IV}O)₂(HPO₄)₂] (or Na₂[(V^{IV}O)₂(PO₄)₂]; CDOS137), wherein each complex optionally has one or more water hydrate. In some embodiments, counterions in the formulae above (e.g., Na⁺, K⁺, and NH₄⁺) can be replaced with other suitable counterions providing for suitable charge balance.

The method for preparing the composition comprising the vanadium(IV) complex can comprise reacting a mixture comprising an aqueous solution of vanadyl(IV) sulfate (VOSO₄) and a buffer selected from a citrate buffer or a phosphate buffer. The aqueous solution of vanadyl(IV) sulfate (VOSO₄) can be formed by dissolving a suitable amount of the compound in deionized water. The buffer is preferably added incrementally to the mixture, such as dropwise, or in aliquots such as 2, 3, 4, 5, 6, 7, 8, 9, 10 or more aliquots. In some examples, the buffer can be added in 10 μL or more, 20 μL or more, 30 μL or more, 40 μL or more, 50 μL or more, 60 μL or more, 70 μL or more, 80 μL or more, 90 μL or more, 100 μL or more, 150 μL or more, 200 μL or more, 250 μL or more, 300 μL or more, 350 μL or more, 400 μL or more, 500 μL or more, aliquots to the reaction mixture.

The vanadyl(IV) sulfate can be present in the reaction mixture in any suitable concentration. For example, the vanadyl(IV) sulfate can be present in the reaction mixture at a concentration of 1.5 M or less, 1.4 M or less, 1.3 M or less, 1.2 M or less, 1.1 M or less, 1.0 M or less, 0.9 M or less, 0.8 M or less, 0.7 M or less, 0.6 M or less, 0.5 M or less, 0.4 M or less, 0.3 M or less, 0.2 M or less, 0.1 M or less, 0.09 M or less, 0.08 M or less, 0.07 M or less, 0.06 M or less, 0.05 M or less, 0.04 M or less, 0.03 M or less, 0.02 M or less, or 0.01 M or less. In some examples, the vanadyl(IV) sulfate can be present in the reaction mixture at a concentration of 0.01 M or greater, 0.02 M or greater, 0.03 M or greater, 0.04 M or greater, 0.05 M or greater, 0.06 M or greater, 0.07 M or greater, 0.08 M or greater, 0.09 M or greater, 0.1 M or greater, 0.2 M or greater, 0.3 M or greater, 0.4 M or greater, 0.5 M or greater, 0.6 M or greater, 0.7 M or greater, 0.8 M or greater, 0.9 M or greater, 1 M or greater, 1.1 M or greater, 1.2 M or greater, 1.3 M or greater, 1.4 M or greater, or 1.5 M or greater. In some examples, the vanadyl(IV) sulfate can be present in the reaction mixture at a concentration of from 0.01 M to 1.5 M, from 0.02 M to 1.5 M, from 0.03 M to 1.5 M, from 0.04 M to 1.5 M, from 0.01 M to 1.2 M, from 0.02 M to 1.2 M, from 0.02 M to 1.1 M, or from 0.02 M to 1.0 M.

Citrate and phosphate buffers are known. When a citrate buffer is used in the reaction, the citrate buffer can comprise citric acid and sodium citrate (or other metal ion salt). When a phosphate buffer is used in the reaction, the phosphate buffer can comprise monobasic and dibasic sodium phosphate (or other metal ion salt). In the reaction mixture, the buffer can be present at a concentration of 3 M or less, 2.5 M or less, 2 M or less, 1.8 M or less, 1.6 M or less, 1.5 M or less, 1.4 M or less, 1.3 M or less, 1.2 M or less, 1.1 M or less, 1.0 M or less, 0.9 M or less, 0.8 M or less, 0.7 M or less, 0.6 M or less, 0.5 M or less, 0.4 M or less, 0.3 M or less, 0.2 M or less, 0.1 M or less, 0.09 M or less, 0.08 M or less, 0.07 M or less, 0.06 M or less, 0.05 M or less, 0.04 M or less, 0.03 M or less, 0.02 M or less, or 0.01 M or less. In some examples, the buffer can be present in the reaction mixture at a concentration of 0.01 M or greater, 0.02 M or greater, 0.03 M or greater, 0.04 M or greater, 0.05 M or greater, 0.06 M or greater, 0.07 M or greater, 0.08 M or greater, 0.09 M or greater, 0.1 M or greater, 0.2 M or greater, 0.3 M or greater, 0.4 M or greater, 0.5 M or greater, 0.6 M or greater, 0.7 M or greater, 0.8 M or greater, 0.9 M or greater, 1 M or greater, 1.1 M or greater, 1.2 M or greater, 1.3 M or greater, 1.4 M or greater, or 1.5 M or greater. In some examples, the buffer can be present in the reaction mixture at a concentration of from 0.01 M to 1.5 M, from 0.02 M to 1.5 M, from 0.03 M to 1.5 M, from 0.04 M to 1.5 M, from 0.01 M to 1.2 M, from 0.02 M to 1.2 M, from 0.02 M to 1.1 M, or from 0.02 M to 1.0 M.

The pH of the buffer can be from 5.5 to 8, from 5.5 to 7.8, from 5.5 to 7.5, from 5.5 to 7.4, from 5.7 to 7.5, from 5.8 to 7.5, from 6 to 7.5, from 6.2 to 7.5, from 6.5 to 7.5, or from 6 to 7.

The reaction mixture can include the VOSO₄ and buffer (citrate or phosphate buffer) in a suitable mole ratio such as 1:0.5 or less, 1:1 or less, 1:2 or less, 1:3 or less, 1:4 or less, 1:5 or less, 1:6 or less, 1:7 or less, 1:8 or less, 1:9 or less, or 1:10 or less. In some embodiments, the reaction mixture can include a mole ratio of VOSO₄ to buffer (citrate or phosphate buffer) of 1:0.5 to 1:10, such as 1:1 to 1:10, 1:1 to 1:8, 1:1 to 1:6, 1:1 to 1:5, 1:1 to 1:4, 1:1 to 1:3, or 1:1 to 1:2.

The reaction can be carried out at a pH of 9 or less, 8.5 or less, 8 or less, 7.5 or less, 7.4 or less, 7.3 or less, 7.2 or less, 7.1 or less, 7.0 or less, 6.9 or less, 6.8 or less, 6.7 or less, 6.6 or less, or 6.5 or less. In some examples, the reaction can be carried out at a pH from 6 to 9, from 6 to 8.5, from 6 to 8, from 6 to 7.5, from 6.5 to 9, from 6.5 to 8.5, from 6.5 to 8, or from 6.5 to 7.5. A base (such as sodium hydroxide) or acid (such as hydrochloric acid) can be added to the reaction mixture to obtain the desired pH.

The reaction to form the vanadium(IV) complex can be carried out at any suitable temperature. In some embodiments, the reaction can be carried out at a temperature of 0° C. or greater, such as 2° C. or greater, 4° C. or greater, 5° C. or greater, 8° C. or greater, 10° C. or greater, 12° C. or greater, 15° C. or greater, 20° C. or greater, or 25° C. or greater. In some examples, the reaction can be carried out at ambient temperature. In some embodiments, the methods for preparing a composition comprising a vanadium(IV) complex can comprise heating the mixture to a temperature of 70° C. or less, such as from 40° C. to 60° C. or from 40° C. to 50° C.

The reaction to form the vanadium(IV) complex can be carried out under inert environment (such as under argon or nitrogen) or under standard atmospheric conditions (including standard temperature and pressure).

At the end of the reaction, a polar organic solvent can be added to the mixture to induce crystallization of the vanadium(IV) complex. For example, methanol, isopropanol, acetone, ethyl acetate, ether, acetonitrile, or a combination thereof can be added to induce crystallization.

Generally, the reaction provides a yield for the vanadium(IV) complex of at least 50% by weight, at least 60% by weight, at least 70% by weight, at least 75% by weight, at least 80% by weight, at least 85% by weight, at least 90% by weight, at least 95% by weight, at least 97% by weight, at least 99% by weight, or up to 100% by weight, based on the weight of the theoretical yield.

The reaction composition (comprising the vanadium(IV) complex, buffer, etc) can comprise at least 30% by weight vanadium(IV) complex, such as at least 50% by weight, at least 60% by weight, at least 70% by weight, at least 75% by weight, at least 80% by weight, at least 85% by weight, at least 90% by weight, at least 95% by weight, at least 97% by weight, at least 99% by weight, or up to 100% by weight, based on the total weight of the reaction composition.

The reaction composition can comprise less than 15% by weight side products or excess reactants, such as less than 12% by weight, less than 10% by weight, less than 9% by weight, less than 8% by weight, less than 7% by weight, less than 6% by weight, less than 5% by weight, less than 4% by weight, less than 3% by weight, less than 2% by weight, or less than 1% by weight, side products or excess reactants in the reaction mixture.

A Second Method for Preparation of Vanadium(IV) Complexes

In another aspect of the present disclosure, a second method for preparing a composition comprising a vanadium(IV) complex is provided. In some examples, the prepared vanadium complex can include a vanadium(IV) citrate complex comprising vanadium(IV) and citrate in a mole ratio of 1:1 to 1:4, such as 1:1, 1:2, 1:3, or 1:4. In other examples, the prepared vanadium complex can include a vanadium(IV) phosphate complex comprising vanadium(IV) and phosphate in a mole ratio of 1:1 to 1:4, such as 1:1, 1:2, 1:3, or 1:4. Specific examples of the vanadium(IV) complex are described herein.

The second method for preparing the composition comprising the vanadium(IV) complex can comprise reacting a mixture comprising an aqueous solution of vanadyl(IV) sulfate (VOSO₄) and citric acid or phosphoric acid. The citric acid or phosphoric acid is preferably added incrementally to the mixture, such as dropwise, or in aliquots such as 2, 3, 4, 5, 6, 7, 8, 9, 10 or more aliquots. In some examples, the citric acid or phosphoric acid can be added in 10 μL or more, 20 μL or more, 30 μL or more, 40 μL or more, 50 μL or more, 60 μL or more, 70 μL or more, 80 μL or more, 90 μL or more, 100 μL or more, 150 μL or more, 200 μL or more, 250 μL or more, 300 μL or more, 350 μL or more, 400 μL or more, 500 μL or more, aliquots to the reaction mixture.

The vanadyl(IV) sulfate can be present in the reaction mixture in any suitable concentration. For example, the vanadyl(IV) sulfate can be present in the reaction mixture at a concentration of 1.5 M or less, 1.4 M or less, 1.3 M or less, 1.2 M or less, 1.1 M or less, 1.0 M or less, 0.9 M or less, 0.8 M or less, 0.7 M or less, 0.6 M or less, 0.5 M or less, 0.4 M or less, 0.3 M or less, 0.2 M or less, 0.1 M or less, 0.09 M or less, 0.08 M or less, 0.07 M or less, 0.06 M or less, 0.05 M or less, 0.04 M or less, 0.03 M or less, 0.02 M or less, or 0.01 M or less. In some examples, the vanadyl(IV) sulfate can be present in the reaction mixture at a concentration of 0.01 M or greater, 0.02 M or greater, 0.03 M or greater, 0.04 M or greater, 0.05 M or greater, 0.06 M or greater, 0.07 M or greater, 0.08 M or greater, 0.09 M or greater, 0.1 M or greater, 0.2 M or greater, 0.3 M or greater, 0.4 M or greater, 0.5 M or greater, 0.6 M or greater, 0.7 M or greater, 0.8 M or greater, 0.9 M or greater, 1 M or greater, 1.1 M or greater, 1.2 M or greater, 1.3 M or greater, 1.4 M or greater, or 1.5 M or greater. In some examples, the vanadyl(IV) sulfate can be present in the reaction mixture at a concentration of from 0.01 M to 1.5 M, from 0.02 M to 1.5 M, from 0.03 M to 1.5 M, from 0.04 M to 1.5 M, from 0.01 M to 1.2 M, from 0.02 M to 1.2 M, from 0.02 M to 1.1 M, or from 0.02 M to 1.0 M.

In the reaction mixture, the citric acid or phosphoric acid can be present at a concentration of 3 M or less, 2.5 M or less, 2 M or less, 1.8 M or less, 1.6 M or less, 1.5 M or less, 1.4 M or less, 1.3 M or less, 1.2 M or less, 1.1 M or less, 1.0 M or less, 0.9 M or less, 0.8 M or less, 0.7 M or less, 0.6 M or less, 0.5 M or less, 0.4 M or less, 0.3 M or less, 0.2 M or less, 0.1 M or less, 0.09 M or less, 0.08 M or less, 0.07 M or less, 0.06 M or less, 0.05 M or less, 0.04 M or less, 0.03 M or less, 0.02 M or less, or 0.01 M or less. In some examples, the citric acid or phosphoric acid can be present in the reaction mixture at a concentration of 0.01 M or greater, 0.02 M or greater, 0.03 M or greater, 0.04 M or greater, 0.05 M or greater, 0.06 M or greater, 0.07 M or greater, 0.08 M or greater, 0.09 M or greater, 0.1 M or greater, 0.2 M or greater, 0.3 M or greater, 0.4 M or greater, 0.5 M or greater, 0.6 M or greater, 0.7 M or greater, 0.8 M or greater, 0.9 M or greater, 1 M or greater, 1.1 M or greater, 1.2 M or greater, 1.3 M or greater, 1.4 M or greater, or 1.5 M or greater. In some examples, the citric acid or phosphoric acid can be present in the reaction mixture at a concentration of from 0.01 M to 1.5 M, from 0.02 M to 1.5 M, from 0.03 M to 1.5 M, from 0.04 M to 1.5 M, from 0.01 M to 1.2 M, from 0.02 M to 1.2 M, from 0.02 M to 1.1 M, or from 0.02 M to 1.0 M.

The reaction mixture can include the VOSO₄ and citric acid or phosphoric acid in a suitable mole ratio such as 1:0.5 or less, 1:1 or less, 1:2 or less, 1:3 or less, 1:4 or less, 1:5 or less, 1:6 or less, 1:7 or less, 1:8 or less, 1:9 or less, or 1:10 or less. In some embodiments, the reaction mixture can include a mole ratio of VOSO₄ to citric acid or phosphoric acid of 1:0.5 to 1:10, such as 1:1 to 1:10, 1:1 to 1:8, 1:1 to 1:6, 1:1 to 1:5, 1:1 to 1:4, 1:1 to 1:3, or 1:1 to 1:2.

The reaction can be carried out at a pH of less than 8, pH of 7.5 or less, 7.4 or less, 7.3 or less, 7.2 or less, 7.1 or less, 7.0 or less, 6.9 or less, 6.8 or less, 6.7 or less, 6.6 or less, 6.5 or less, 6.3 or less, 6.2 or less, 6.0 or less, 5.8 or less, 5.7 or less, 5.6 or less, 5.5 or less, 5.4 or less, 5.2 or less, 5.0 or less, 4.9 or less, 4.8 or less, 4.7 or less, 4.6 or less, or 4.5 or less. In some examples, the reaction can be carried out at a pH from 4 to less than 8, from 4 to 7.5, from 4 to 7, from 4 to 6.5, from 4 to 6, from 4 to 5.5, from 4 to 5, from 4.5 to 7.5, from 4.5 to 7, from 4.5 to 6.5, from 4.5 to 6, from 4.5 to 5.5, or from 4.5 to 5. A base (such as sodium hydroxide) or acid (such as hydrochloric acid) can be added to the reaction mixture to obtain the desired pH.

The reaction to form the vanadium(IV) complex can be carried out at any suitable temperature. In some embodiments, the reaction can be carried out at a temperature of 0° C. or greater, such as 2° C. or greater, 4° C. or greater, 5° C. or greater, 8° C. or greater, 10° C. or greater, 12° C. or greater, 15° C. or greater, 20° C. or greater, or 25° C. or greater. In some examples, the reaction can be carried out at ambient temperature. In some embodiments, the methods for preparing a composition comprising a vanadium(IV) complex can comprise heating the mixture to a temperature of 70° C. or less, such as from 40° C. to 60° C. or from 40° C. to 50° C.

The reaction to form the vanadium(IV) complex can be carried out under inert environment (such as under argon or nitrogen) or under standard atmospheric conditions (including standard temperature and pressure).

At the end of the reaction, a polar organic solvent can be added to the mixture to induce crystallization of the vanadium(IV) complex. For example, methanol, isopropanol, acetone, ethyl acetate, ether, acetonitrile, or a combination thereof can be added to induce crystallization.

Generally, the reaction provides a yield for the vanadium(IV) complex of at least 50% by weight, at least 60% by weight, at least 70% by weight, at least 75% by weight, at least 80% by weight, at least 85% by weight, at least 90% by weight, at least 95% by weight, at least 97% by weight, at least 99% by weight, or up to 100% by weight, based on the weight of the theoretical yield.

The reaction composition (comprising the vanadium(IV) complex, solvent, etc) can comprise at least 30% by weight vanadium(IV) complex, such as at least 50% by weight, at least 60% by weight, at least 70% by weight, at least 75% by weight, at least 80% by weight, at least 85% by weight, at least 90% by weight, at least 95% by weight, at least 97% by weight, at least 99% by weight, or up to 100% by weight, based on the total weight of the reaction composition.

The reaction composition can comprise less than 15% by weight side products or excess reactants, such as less than 12% by weight, less than 10% by weight, less than 9% by weight, less than 8% by weight, less than 7% by weight, less than 6% by weight, less than 5% by weight, less than 4% by weight, less than 3% by weight, less than 2% by weight, or less than 1% by weight, side products or excess reactants in the reaction mixture.

Preparation of Vanadium(V) Complexes

In another aspect of the present disclosure, a method for preparing a composition comprising a vanadium(V) complex is provided. In some examples, the prepared vanadium complex can include a vanadium(V) citrate complex comprising vanadium(V) and citrate in a mole ratio of 1:1 to 1:4, such as 1:1, 1:2, 1:3, or 1:4. Specific examples of the vanadium(V) complex include Na₆[(V^{V}₂O₂(O₂)₂(C₆H₄O₇)₂] (CDOS140); Na₄[(V^{V}O₂)(C₆H₅O₇)]₂ (CDOS141); K₂[V^{V}₂O₄(C₆H₆O₇)₂], K₄[V^{V}₂O₄(C₆H₅O₇)₂], (NH₄)₆[V^{V}₂O₄(C₆H₄O₇)₂], and K₃[(V^{V}O₂)₂(C₆H₆O₇)(C₆H₅O₇)], wherein each complex optionally has one or more water hydrate.

The method for preparing the composition comprising the vanadium(V) complex can comprise reacting a mixture comprising an aqueous solution of metavanadate (VO₃³⁻) or orthovanadate (VO₄³⁻) compound and a citrate compound selected from citric acid, a citrate salt, a citrate buffer, or a combination thereof. The aqueous solution of metavanadate (VO₃³⁻) or orthovanadate (VO₄³⁻) compound can be formed by dissolving a suitable amount of the compound in deionized water. The citrate compound is preferably added incrementally to the mixture, such as dropwise, or in aliquots such as 2, 3, 4, 5, 6, 7, 8, 9, 10 or more aliquots. In some examples, the citrate compound can be added in 10 μL or more, 20 μL or more, 30 μL or more, 40 μL or more, 50 μL or more, 60 μL or more, 70 μL or more, 80 μL or more, 90 μL or more, 100 μL or more, 150 μL or more, 200 μL or more, 250 μL or more, 300 μL or more, 350 μL or more, 400 μL or more, 500 μL or more, aliquots to the reaction mixture.

In some examples, the metavanadate compound is reacted with a mixture of citric acid and citrate salt. In other examples, the metavanadate or orthovanadate compound is reacted with the citrate buffer.

The metavanadate or orthovanadate compound can be present in the reaction mixture in any suitable concentration. For example, the metavanadate or orthovanadate compound can be present in the reaction mixture at a concentration of 1.5 M or less, 1.4 M or less, 1.3 M or less, 1.2 M or less, 1.1 M or less, 1.0 M or less, 0.9 M or less, 0.8 M or less, 0.7 M or less, 0.6 M or less, 0.5 M or less, 0.4 M or less, 0.3 M or less, 0.2 M or less, 0.1 M or less, 0.09 M or less, 0.08 M or less, 0.07 M or less, 0.06 M or less, 0.05 M or less, 0.04 M or less, 0.03 M or less, 0.02 M or less, or 0.01 M or less. In some examples, the metavanadate or orthovanadate compound can be present in the reaction mixture at a concentration of 0.01 M or greater, 0.02 M or greater, 0.03 M or greater, 0.04 M or greater, 0.05 M or greater, 0.06 M or greater, 0.07 M or greater, 0.08 M or greater, 0.09 M or greater, 0.1 M or greater, 0.2 M or greater, 0.3 M or greater, 0.4 M or greater, 0.5 M or greater, 0.6 M or greater, 0.7 M or greater, 0.8 M or greater, 0.9 M or greater, 1 M or greater, 1.1 M or greater, 1.2 M or greater, 1.3 M or greater, 1.4 M or greater, or 1.5 M or greater. In some examples, the metavanadate or orthovanadate compound can be present in the reaction mixture at a concentration of from 0.01 M to 1.5 M, from 0.02 M to 1.5 M, from 0.03 M to 1.5 M, from 0.04 M to 1.5 M, from 0.01 M to 1.2 M, from 0.02 M to 1.2 M, from 0.02 M to 1.1 M, or from 0.02 M to 1.0 M.

As described herein, the citrate compound can be selected from citric acid, a citrate salt, a citrate buffer, or a combination thereof. As further described herein, citrate buffers and salts are known. The citrate buffer is used in the reaction, the citrate buffer can comprise citric acid and sodium citrate (or other metal ion salt). The citrate salt can include a sodium, potassium citrate salt, or other metal ion citrate salts.

In the reaction mixture, the citrate compound can be present at a concentration of 3 M or less, 2.5 M or less, 2 M or less, 1.8 M or less, 1.6 M or less, 1.5 M or less, 1.4 M or less, 1.3 M or less, 1.2 M or less, 1.1 M or less, 1.0 M or less, 0.9 M or less, 0.8 M or less, 0.7 M or less, 0.6 M or less, 0.5 M or less, 0.4 M or less, 0.3 M or less, 0.2 M or less, 0.1 M or less, 0.09 M or less, 0.08 M or less, 0.07 M or less, 0.06 M or less, 0.05 M or less, 0.04 M or less, 0.03 M or less, 0.02 M or less, or 0.01 M or less. In some examples, the citrate compound can be present in the reaction mixture at a concentration of 0.01 M or greater, 0.02 M or greater, 0.03 M or greater, 0.04 M or greater, 0.05 M or greater, 0.06 M or greater, 0.07 M or greater, 0.08 M or greater, 0.09 M or greater, 0.1 M or greater, 0.2 M or greater, 0.3 M or greater, 0.4 M or greater, 0.5 M or greater, 0.6 M or greater, 0.7 M or greater, 0.8 M or greater, 0.9 M or greater, 1 M or greater, 1.1 M or greater, 1.2 M or greater, 1.3 M or greater, 1.4 M or greater, or 1.5 M or greater. In some examples, the citrate compound can be present in the reaction mixture at a concentration of from 0.01 M to 1.5 M, from 0.02 M to 1.5 M, from 0.03 M to 1.5 M, from 0.04 M to 1.5 M, from 0.01 M to 1.2 M, from 0.02 M to 1.2 M, from 0.02 M to 1.1 M, or from 0.02 M to 1.0 M.

The pH of the citrate compound can be from 5.5 to 8, from 5.5 to 7.8, from 5.5 to 7.5, from 5.5 to 7.4, from 5.7 to 7.5, from 5.8 to 7.5, from 6 to 7.5, from 6.2 to 7.5, from 6.5 to 7.5, or from 6 to 7.

The reaction mixture can include the metavanadate or orthovanadate compound and citrate compound in a suitable mole ratio such as 1:0.5 or less, 1:1 or less, 1:2 or less, 1:3 or less, 1:4 or less, 1:5 or less, 1:6 or less, 1:7 or less, 1:8 or less, 1:9 or less, or 1:10 or less. In some embodiments, the reaction mixture can include a mole ratio of metavanadate or orthovanadate compound to citrate compound of 1:0.5 to 1:10, such as 1:1 to 1:10, 1:1 to 1:8, 1:1 to 1:6, 1:1 to 1:5, 1:1 to 1:4, 1:1 to 1:3, or 1:1 to 1:2.

The reaction can be carried out at a pH of 9 or less, 8.5 or less, 8 or less, 7.5 or less, 7.4 or less, 7.3 or less, 7.2 or less, 7.1 or less, 7.0 or less, 6.9 or less, 6.8 or less, 6.7 or less, 6.6 or less, or 6.5 or less. In some examples, the reaction can be carried out at a pH from 6 to 9, from 6 to 8.5, from 6 to 8, from 6 to 7.5, from 6.5 to 9, from 6.5 to 8.5, from 6.5 to 8, or from 6.5 to 7.5. A base (such as sodium hydroxide) or acid (such as hydrochloric acid) can be added to the reaction mixture to obtain the desired pH.

The reaction to form the vanadium(V) complex can be carried out at any suitable temperature. In some embodiments, the reaction can be carried out at a temperature of 0° C. or greater, such as 2° C. or greater, 4° C. or greater, 5° C. or greater, 8° C. or greater, 10° C. or greater, 12° C. or greater, 15° C. or greater, 20° C. or greater, or 25° C. or greater. In some examples, the reaction can be carried out at ambient temperature. In some embodiments, the methods for preparing a composition comprising a vanadium(V) complex can comprise heating the mixture to a temperature of 70° C. or less, such as from 40° C. to 60° C. or from 40° C. to 50° C.

The reaction to form the vanadium(V) complex can be carried out under inert environment (such as under argon or nitrogen) or under standard atmospheric conditions (including standard temperature and pressure).

At the end of the reaction, a polar organic solvent can be added to the mixture to induce crystallization of the vanadium(V) complex. For example, methanol, isopropanol, acetone, ethyl acetate, ether, acetonitrile, or a combination thereof can be added to induce crystallization.

Generally, the reaction provides a yield for the vanadium(V) complex of at least 50% by weight, at least 60% by weight, at least 70% by weight, at least 75% by weight, at least 80% by weight, at least 85% by weight, at least 90% by weight, at least 95% by weight, at least 97% by weight, at least 99% by weight, or up to 100% by weight, based on the weight of the theoretical yield.

The reaction composition (comprising the vanadium(V) complex, solvent, etc) can comprise at least 30% by weight vanadium(V) complex, such as at least 50% by weight, at least 60% by weight, at least 70% by weight, at least 75% by weight, at least 80% by weight, at least 85% by weight, at least 90% by weight, at least 95% by weight, at least 97% by weight, at least 99% by weight, or up to 100% by weight, based on the total weight of the reaction composition.

The reaction composition can comprise less than 15% by weight side products or excess reactants, such as less than 12% by weight, less than 10% by weight, less than 9% by weight, less than 8% by weight, less than 7% by weight, less than 6% by weight, less than 5% by weight, less than 4% by weight, less than 3% by weight, less than 2% by weight, or less than 1% by weight, side products or excess reactants in the reaction mixture.

A Scaled-up Method for Preparation of Vanadium(V) Complexes

In a further aspect of the present disclosure, a scaled-up method for preparing a composition comprising a vanadium(V) complex is provided. In some examples, the prepared vanadium complex can include a vanadium(V) citrate complex comprising vanadium(V) and citrate in a mole ratio of 1:1 to 1:4, such as 1:1, 1:2, 1:3, or 1:4. Specific examples of the vanadium(V) complex are as described herein, such as K₃[(V^{V}O₂)₂(C₆H₆O₇)(C₆H₅O₇)], wherein the complex optionally has one or more water hydrate.

The method for preparing the composition comprising the vanadium(V) complex can comprise adding citric acid to a basic solution of V₂O₅ compound and allowing the citric acid and V₂O₅ compound to react. The basic solution of V₂O₅ compound can be formed by dissolving a suitable amount of the compound in deionized water, followed by addition of a base (such as potassium hydroxide). The citric acid is preferably added incrementally to the mixture, such as dropwise, or in aliquots such as 2, 3, 4, 5, 6, 7, 8, 9, 10 or more aliquots.

The V₂O₅ compound can be present in the reaction mixture in any suitable concentration. For example, the V₂O₅ compound can be present in the reaction mixture at a concentration of 1.5 M or less, 1.4 M or less, 1.3 M or less, 1.2 M or less, 1.1 M or less, 1.0 M or less, 0.9 M or less, 0.8 M or less, 0.7 M or less, 0.6 M or less, 0.5 M or less, 0.4 M or less, 0.3 M or less, 0.2 M or less, 0.1 M or less, 0.09 M or less, 0.08 M or less, 0.07 M or less, 0.06 M or less, 0.05 M or less, 0.04 M or less, 0.03 M or less, 0.02 M or less, or 0.01 M or less. In some examples, the V₂O₅ compound can be present in the reaction mixture at a concentration of 0.01 M or greater, 0.02 M or greater, 0.03 M or greater, 0.04 M or greater, 0.05 M or greater, 0.06 M or greater, 0.07 M or greater, 0.08 M or greater, 0.09 M or greater, 0.1 M or greater, 0.2 M or greater, 0.3 M or greater, 0.4 M or greater, 0.5 M or greater, 0.6 M or greater, 0.7 M or greater, 0.8 M or greater, 0.9 M or greater, 1 M or greater, 1.1 M or greater, 1.2 M or greater, 1.3 M or greater, 1.4 M or greater, or 1.5 M or greater. In some examples, the V₂O₅ compound can be present in the reaction mixture at a concentration of from 0.01 M to 1.5 M, from 0.02 M to 1.5 M, from 0.03 M to 1.5 M, from 0.04 M to 1.5 M, from 0.01 M to 1.2 M, from 0.02 M to 1.2 M, from 0.02 M to 1.1 M, or from 0.02 M to 1.0 M.

In the reaction mixture, the citric acid can be present at a concentration of 3 M or less, 2.5 M or less, 2 M or less, 1.8 M or less, 1.6 M or less, 1.5 M or less, 1.4 M or less, 1.3 M or less, 1.2 M or less, 1.1 M or less, 1.0 M or less, 0.9 M or less, 0.8 M or less, 0.7 M or less, 0.6 M or less, 0.5 M or less, 0.4 M or less, 0.3 M or less, 0.2 M or less, 0.1 M or less, 0.09 M or less, 0.08 M or less, 0.07 M or less, 0.06 M or less, 0.05 M or less, 0.04 M or less, 0.03 M or less, 0.02 M or less, or 0.01 M or less. In some examples, the citric acid can be present in the reaction mixture at a concentration of 0.01 M or greater, 0.02 M or greater, 0.03 M or greater, 0.04 M or greater, 0.05 M or greater, 0.06 M or greater, 0.07 M or greater, 0.08 M or greater, 0.09 M or greater, 0.1 M or greater, 0.2 M or greater, 0.3 M or greater, 0.4 M or greater, 0.5 M or greater, 0.6 M or greater, 0.7 M or greater, 0.8 M or greater, 0.9 M or greater, 1 M or greater, 1.1 M or greater, 1.2 M or greater, 1.3 M or greater, 1.4 M or greater, or 1.5 M or greater. In some examples, the citric acid can be present in the reaction mixture at a concentration of from 0.01 M to 1.5 M, from 0.02 M to 1.5 M, from 0.03 M to 1.5 M, from 0.04 M to 1.5 M, from 0.01 M to 1.2 M, from 0.02 M to 1.2 M, from 0.02 M to 1.1 M, or from 0.02 M to 1.0 M.

The reaction mixture can include the V₂O₅ compound and citric acid in a suitable mole ratio such as 1:0.5 or less, 1:1 or less, 1:2 or less, 1:3 or less, 1:4 or less, 1:5 or less, 1:6 or less, 1:7 or less, 1:8 or less, 1:9 or less, or 1:10 or less. In some embodiments, the reaction mixture can include a mole ratio of V₂O₅ compound to citric acid of 1:0.5 to 1:10, such as 1:1 to 1:10, 1:1 to 1:8, 1:1 to 1:6, 1:1 to 1:5, 1:1 to 1:4, 1:1 to 1:3, or 1:1 to 1:2.

The reaction can be carried out at a pH of 8 or less, 7.5 or less, 7.4 or less, 7.3 or less, 7.2 or less, 7.1 or less, 7.0 or less, 6.9 or less, 6.8 or less, 6.7 or less, 6.6 or less, 6.5 or less, 6.3 or less, 6.2 or less, 6.0 or less, 5.8 or less, 5.7 or less, 5.6 or less, 5.5 or less, 5.4 or less, 5.2 or less, 5.0 or less, 4.9 or less, 4.8 or less, 4.7 or less, 4.6 or less, or 4.5 or less. In some examples, the reaction can be carried out at a pH from 4 to 8, from 4 to 7.5, from 4 to 7, from 4 to 6.5, from 4 to 6, from 4 to 5.5, from 4 to 5, from 4.5 to 7.5, from 4.5 to 7, from 4.5 to 6.5, from 4.5 to 6, from 4.5 to 5.5, or from 4.5 to 5. A base (such as sodium hydroxide or potassium hydroxide) or acid (such as hydrochloric acid) can be added to the reaction mixture to obtain the desired pH.

The reaction to form the vanadium(V) complex can be carried out at any suitable temperature. In some embodiments, the reaction can be carried out at a temperature of 0° C. or greater, such as 2° C. or greater, 4° C. or greater, 5° C. or greater, 8° C. or greater, 10° C. or greater, 12° C. or greater, 15° C. or greater, 20° C. or greater, or 25° C. or greater. In some examples, the reaction can be carried out at ambient temperature. In some embodiments, the methods for preparing a composition comprising a vanadium(V) complex can comprise heating the mixture to a temperature of 70° C. or less, such as from 40° C. to 60° C. or from 40° C. to 50° C.

The reaction to form the vanadium(V) complex can be carried out under inert environment (such as under argon or nitrogen) or under standard atmospheric conditions (including standard temperature and pressure).

At the end of the reaction, a polar organic solvent can be added to the mixture to induce crystallization of the vanadium(V) complex. For example, ethanol, methanol, isopropanol, acetone, ethyl acetate, ether, acetonitrile, or a combination thereof can be added to induce crystallization.

Generally, the reaction provides a yield for the vanadium (V) complex of at least 50% by weight, at least 60% by weight, at least 70% by weight, at least 75% by weight, at least 80% by weight, at least 85% by weight, at least 90% by weight, at least 95% by weight, at least 97% by weight, at least 99% by weight, or up to 100% by weight, based on the weight of the theoretical yield. In some examples, the method produces vanadium (V) citrate complex at a concentration of 10 mM or greater.

The reaction composition (comprising the vanadium(V) complex, solvent, etc) can comprise at least 30% by weight vanadium (V) complex, such as at least 50% by weight, at least 60% by weight, at least 70% by weight, at least 75% by weight, at least 80% by weight, at least 85% by weight, at least 90% by weight, at least 95% by weight, at least 97% by weight, at least 99% by weight, or up to 100% by weight, based on the total weight of the reaction composition.

The reaction composition can comprise less than 15% by weight side products or excess reactants, such as less than 12% by weight, less than 10% by weight, less than 9% by weight, less than 8% by weight, less than 7% by weight, less than 6% by weight, less than 5% by weight, less than 4% by weight, less than 3% by weight, less than 2% by weight, or less than 1% by weight, side products or excess reactants in the reaction mixture.

Methods of Use

The vanadium complex obtained from the methods disclosed herein can be used in various compositions without further purification. In some examples, the complexes can be used in the manufacture of a pharmaceutical composition, catalyst, or battery. The pharmaceutical composition can be used for the treatment of a cancer, or as an adjuvant for virus-based vaccine, in a subject in need thereof.

In some embodiments, the citrate and/or phosphate salts of vanadium are used in the manufacture of a pharmaceutical composition. In some embodiments, the pharmaceutical composition further comprises one or more pharmaceutically acceptable carriers and/or excipients.

In some embodiments, the pharmaceutical composition further comprises one or more viruses selected from a therapeutic virus and a prophylactic virus. In some embodiments, the one or more viruses are selected from a non-naturally occurring DNA virus and a non-naturally occurring RNA virus. In some embodiments the one or more viruses are a genetically modified RNA virus, an attenuated RNA virus, or an oncolytic RNA virus, or a mixture thereof.

In some embodiments, the virus is an oncolytic RNA virus. In some embodiments, the oncolytic RNA virus is any suitable oncolytic RNA virus known in the art which infects and lyses cancer or tumor cells as compared to non-cancer or normal cells. For example, in some embodiments, the oncolytic virus is reovirus, newcastle disease virus, adenovirus, herpes virus, polio virus, mumps virus, measles virus, influenza virus, vaccinia virus, and/or rhabdoviruses such as vesicular stomatitis virus and derivatives/variants of each of the above. Examples of oncolytic viruses, and variants or derivatives thereof, are known in the art, for example from U.S. patent application publication nos. 20040115170, 20040170607, and 20020037543; PCT patent application publication no. WO 00/62735; and U.S. Pat. Nos. 7,052,832, 7,063,835, and 7,122,182 (which are each hereby incorporated by reference) and others.

In some embodiments, the virus is a vesicular stomatitis virus (VSV), or a related rhabdovirus variant/derivative thereof, for example, selected under specific growth conditions, one that has been subjected to a range of selection pressures, one that has been genetically modified using recombinant techniques known within the art, or a combination thereof. In some embodiments, the virus is VSVD51. Other derivatives or variants may be based on viruses such as Maraba (MG-1, for example), Farmington virus, rabies, Newcastle disease virus, poliovirus, zika virus, coronavirus, Coxsackie virus, semliki forest virus, ebolavirus, rift valley fever virus, Sindbis virus, Vaccinia virus, Herpes Simplex Virus, Poliovirus, Parvovirus, rotavirus, influenza, hepatitis A, mumps, measles, rubella, reovirus, dengue virus, Chikungunya virus, respiratory syncitial virus, LCMV, lentivirus, or replicating retrovirus, for example, and this is well within the purview of a person skilled in the art.

In some embodiments the pharmaceutical composition comprises a vanadium compound, an oncolytic virus and a pharmaceutically acceptable carrier and/or excipient, wherein the vanadium compound is a citrate salt of vanadium or a phosphate salt of vanadium.

In some embodiments, the amount of the one or more vanadium compounds in the pharmaceutical compositions of the application is that amount that increases the infection, spread, titer, activity, cytotoxicity and/or immunotherapeutic activity the one or more viruses in the pharmaceutical composition.

In some embodiments, the amount of the one or more vanadium compounds in the pharmaceutical compositions of the application is about 1 mg/mL to about 200 mg/mL, about 1 mg/mL to about 100 mg/mL, about 5 mg/mL to about 50 mg/mL, about 10 mg/mL to about 40 mg/mL, about 15 mg/mL to about 30 mg/mL, or about 20 mg/mL.

In some embodiments, the one or more viruses are present in the pharmaceutical composition in therapeutically effective amounts. In some embodiments, the one or more viruses are present in the pharmaceutical composition in therapeutically effective amounts to treat cancer or a tumor.

In some embodiments, the amount of the one or more viruses in the pharmaceutical compositions of the application is about 2.5E9 pfu/ml, or about 2.5E5 pfu/ml to about 2.5E12 pfu/ml.

In some embodiments, the pH of the pharmaceutical compositions of the application is about 6 to about 9. In some embodiments, the pH of the pharmaceutical compositions of the application is about 6.5 to about 8.5. In some embodiments, the pH of the pharmaceutical compositions of the application is about 7 to about 8.

In some embodiments, the pharmaceutical composition comprises, one or more vanadium compounds and the one or more viruses in one or more pharmaceutically acceptable carriers and/or excipients. In an embodiment, the one or more carriers and/or excipients is water and optionally containing other solutes such as dissolved salts and the like. In some embodiments, the solution comprises enough saline, glucose or the like to make the solution isotonic. Pharmaceutical compositions and methods of preparing pharmaceutical compositions are known in the art and are described, for example, in “Remington: The Science and Practice of Pharmacy” (formerly “Remingtons Pharmaceutical Sciences”); Gennaro, A., Lippincott, Williams & Wilkins, Philadelphia, Pa. (2000), herein incorporated by reference.

In some embodiments, the pharmaceutical composition is for administration by injection. In some embodiments, the pharmaceutical composition is for administration by intravenous or intratumor injection. Pharmaceutical compositions suitable for injection include, for example, sterile aqueous solutions or dispersions and sterile powders for the extemporaneous preparation of sterile injectable solutions or dispersions. In all cases, the composition must be sterile and must be fluid to the extent that easy syringability exists.

The compounds and pharmaceutical compositions of the application may be administered to a subject in a variety of forms depending on the selected route of administration, as will be understood by those skilled in the art. A compound of the application may be administered, for example, by oral, parenteral, buccal, sublingual, nasal, rectal, patch, pump or transdermal administration, or injection such as intravenous, intratumoral injection, subcutaneous injection, intraperitoneal injection, bladder or other instillation, and the pharmaceutical compositions formulated accordingly. Administration can be by means of a pump for periodic or continuous delivery. Conventional procedures and ingredients for the selection and preparation of suitable compositions are described, for example, in Remington's Pharmaceutical Sciences (2000-20th edition) and in The United States Pharmacopeia: The National Formulary (USP 24 NF19) published in 1999.

The present application further includes a kit comprising: one or more vanadium compounds of the present application; and one or more viruses.

The present application further includes a kit comprising: a pharmaceutical composition of the present application.

In some embodiments, additional components are included in the kits of the present application, such as one or more pharmaceutically acceptable carriers, excipients, administration means (e.g., syringes), and/or instructions for use. Selection of additional suitable components is well within the purview of a person skilled in the art.

In some embodiments, the pharmaceutical compositions of the present application further comprise one or more additional therapeutic agents, for example one or more anticancer agents known in the art.

The present application also includes a use of one or more vanadium compounds of the application as an adjuvant in the manufacture of a virus-based vaccine, such as an RNA virus-based cancer vaccine.

The present application also includes a method or preparing a virus-based vaccine comprising combining one or more vanadium compounds of the application with one or more viruses under conditions to prepare a vaccine. In some embodiments, the one or more viruses are oncolytic viruses, such as oncolytic RNA virus, and the vaccine is a cancer vaccine.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.), but some errors and deviations should be accounted for. Unless indicated otherwise, parts are parts by mole (molarity/molar ratio), temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1: Preparation of Vanadium-Citrate and Vanadium-Phosphate Complexes

In the following example, preparation methods and characterization of vanadium-citrate complexes are described. Specifically, new preparation methods of vanadium-citrate and vanadium phosphate complexes are developed.

A number of vanadium citrate complexes have been reported. Many of them have been characterized by X-ray crystallography, and this example demonstrates that the complexes vary in their coordination chemistries, oxidation states and protonation states of the complexes, as well as different stoichiometries. This is a complex system because the complexes tend to interconvert at different pH values, and this has been observed for V(V), V(IV), and peroxovanadium complexes. Below are known vanadium-citrate complexes:

K₂[V₂O₄(C₆H₆O₇)₂].4H₂O

K₄[V₂O₄(C₆H₅O₇)₂].5.6H₂O

K₂[V₂O₂(O₂)₂(C₆H₆Oy)₂].2H₂O

K₄[V₂O₂(C₆H₄O₇)₂].6H₂O

K₃[V₂O₂(C₆H₄O₇)(C₆H₅O₇)].7H₂O

(NH₄)₄[V₂O₂(C₆H₄O₇)₂].2H₂O

(NH₄)₆[V₂O₄(C₆H₄O₇)₂].6H₂O

Solution Preparation of V-Citrate and V-Phosphate Complexes: This Section describes new preparations of vanadium-citrate and vanadium-phosphate materials based on the concept of preparing the materials in solution and using them without isolation. These preparations are advantageous in that solutions containing vanadium-citrate and vanadium-phosphate materials are at physiological pH.

Detailed Experimental Procedures

General Materials: Sodium metavanadate (≥98.0%, Sigma Aldrich), sodium citrate dihydrate (≥99.0%, Fischer Scientific), citric acid monohydrate (≥99.0%, Fischer Scientific), isopropanol (ACS reagent, ≥99.5%, Sigma Aldrich), methanol (ACS reagent, ≥99.8%, Sigma Aldrich) and deuterium oxide (D, 99.5%, Cambridge Isotope Laboratories) were purchased and used as received.

Citrate buffer (0.200 M, pH 6.20) was prepared using a method as described by Sigma Aldrich: citric acid (0.336 g, 0.0016 mol) and sodium citrate tribasic (4.748 g, 0.0184 mol) in 100.0 mL water. Phosphate buffer (1 M) was prepared by using the following recipe: 14.2 g of Na₂HPO₄ and 2 g NaOH in 100.0 mL water.

General Methods: All syntheses were performed exposed to air unless otherwise noted. ¹H and ⁵¹V NMR experiments were recorded on a 400 MHz Bruker NMR spectrometer at 400 MHz and 105.2 MHz for vanadium, respectively. The ¹H NMR parameters were as follows: 16 scans in the F1 domain, 1.0 s relaxation delay, 450 pulse angle, and 11 ρs pulse. The ¹H NMR spectra in D₂O were reported against an internal standard of sodium trimethylsilylpropanesulfonate (DSS) at 0.00 ppm. The ⁵¹V NMR parameters were as follows: 4096 scans in the F1 domain, 0.01 s relaxation delay, 45° pulse angle, and 16 ρs pulse. The ⁵¹V NMR spectra were reported relative to a neat VOCl₃ external standard at 0 ppm. The lock was turned off, and shimming was skipped for both ¹H and ⁵¹V NMR spectra collected in non-deuterated water, and the samples were also referenced to an internal DSS standard at 0.00 ppm. All ¹H NMR spectra were collected with and without water suppression. The data was processed using MestreNova NMR processing software (version 14.0.1).

The CW-EPR spectra were recorded on a Bruker X-band EPR spectrometer (9.84 GHz) at ambient temperature by using the following parameters: 3500 G center field, 3500 G field position, 1500 G sweep width, 100.00 kHz modulation frequency, 10.000 G modulation amplitude, 16 scans. The solutions were recorded in 1 mm glass capillary tubes placed in 2 mm quartz tubes. A powder sample of 2,2-diphenyl-1-picrylhydrazyl (DPPH, g=2.0037) was used as an external standard. Receiver gain was varied depending on the intensity of a sample; unless stated otherwise, samples were collected at 60 dB. The data was processed by using MatLab (version R2019a) with an EasySpin open-source toolbox.

Solution Preparations from VOSO₄ in Buffers (Citrate and Phosphate)

Preparation of the V^{IV}Cit Complex in Solution from a 1.20 M citrate buffer-1:1 ratio VOSO₄-Cit (CDOS149, HM): To a 120 mM stirring aqueous solution of VOSO₄ (0.282 g, 1.20 mmol in 10.0 mL DDI water), 2.10 mL of 1.2 M a citrate buffer (2.46 mmol citrate pH 6.20) was added in 100 μL aliquots. The pH of the final solution was at 7.23. The solution was stored under argon at 4° C. until further use. Yield: 100%. Final vanadium concentration: 96.0 mM. Final volume: 12.1 mL.

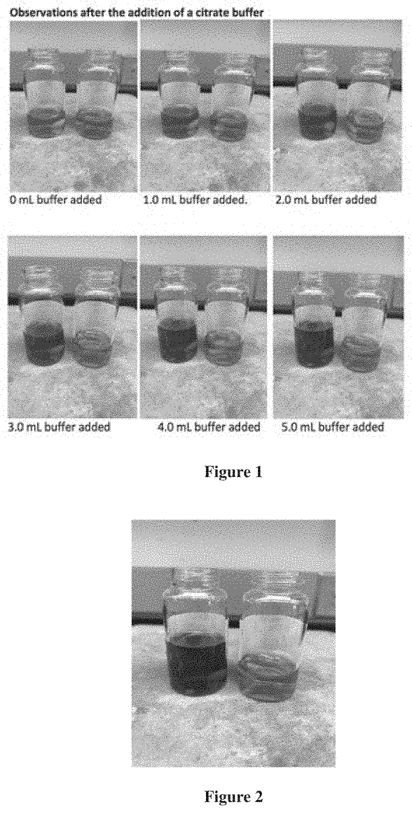

Preparation of the V^{IV}Cit Complex in Solution from a 0.200 M a citrate buffer-1:1 ratio VOSO₄-Cit: To a 200 mM stirring aqueous VOSO₄ solution (5.0 mL), 5.0 mL of a 200 mM citrate buffer (pH 6.20) was added slowly. The pH of the solution was adjusted to 6.46 by adding 9 drops of 6M NaOH and 2 drops of 1M NaOH (or 6 drops 6M NaOH and 1 drop 1M NaOH). The solution was stored under Argon until further use (FIG. 1). Yield: 100%. Final volume: 10.0 mL. Final concentration: 100.0 mM.

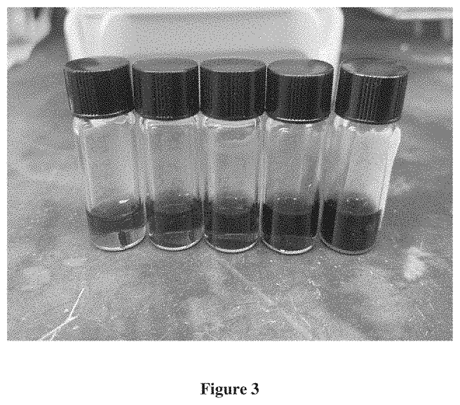

Preparation of the VOSO₄ added a citrate buffer—1:2 ratio of VOSO₄-2Cit (CDOS136)—Molecular Formula (presumed): Na₃[(V^{IV}O)₂(C₆H₄O₇)(C₆H₅O₇)]. Molecular Weight: 579.89 g/mol. Color: dark blue. Solid VOSO₄ (0.235 g, 1.00 mmol) was weighed out into a 20 mL clean scintillation vial and dissolved in 10.0 mL of DDI water, resulting in a 100 mM VOSO₄ aqueous solution. The resulting solution was sonicated for 30 seconds until vanadyl sulfate has dissolved. This was followed by the slow addition of the 1 M citrate buffer (1.49 mL, 1.49 mmol) in 100 μL aliquots until the final pH reached 7, FIGS. 2 and 3. The citrate buffer was added in 10 μL aliquots as the pH was getting closer to 7. Final concentration—100 mM. Final pH—7. Yield: 100%. EPR (at pH 2.57): g(1)=1.956, g(2)=1.999, A1=415 MHz, A2=109 MHz (FIG. 4A) EPR (at pH 3.02): g(1)=1.946, g(2)=1.990, A1=432 MHz, A2=70 MHz (FIG. 4B). EPR (at pH 4.09): g(1)=1.956, g(2)=1.984, A1=431 MHz, A2=82 MHz (FIG. 4C). EPR (at pH 5.00): g(1)=1.956, g(2)=1.984, A1=431 MHz, A2=82 MHz (FIG. 4D). EPR (at pH 6.27): no signal (FIG. 4E).

Preparation of the VOSO₄ added a citrate butter—1:2 ratio of VOSO₄-2Cit: To a 9 mL stirring 110.0 mM aqueous solution of VOSO₄, 1000 μL of a 1.2 M sodium citrate buffer were added in 50 μL increments until the pH reached 7. The resulting solution concentration was 100.0 mM. The solution was immediately stored under argon until further use. Yield: 100%. ¹H NMR (400 MHz, non-deuterated water): 2.58 (dd) ppm. EPR Spin Hamiltonian parameters (EasySpin “garlic” simulation): g_{II}=1.967, g_{⊥}=1.989, A_{II}=390 MHz, A_{⊥}=44 MHz.

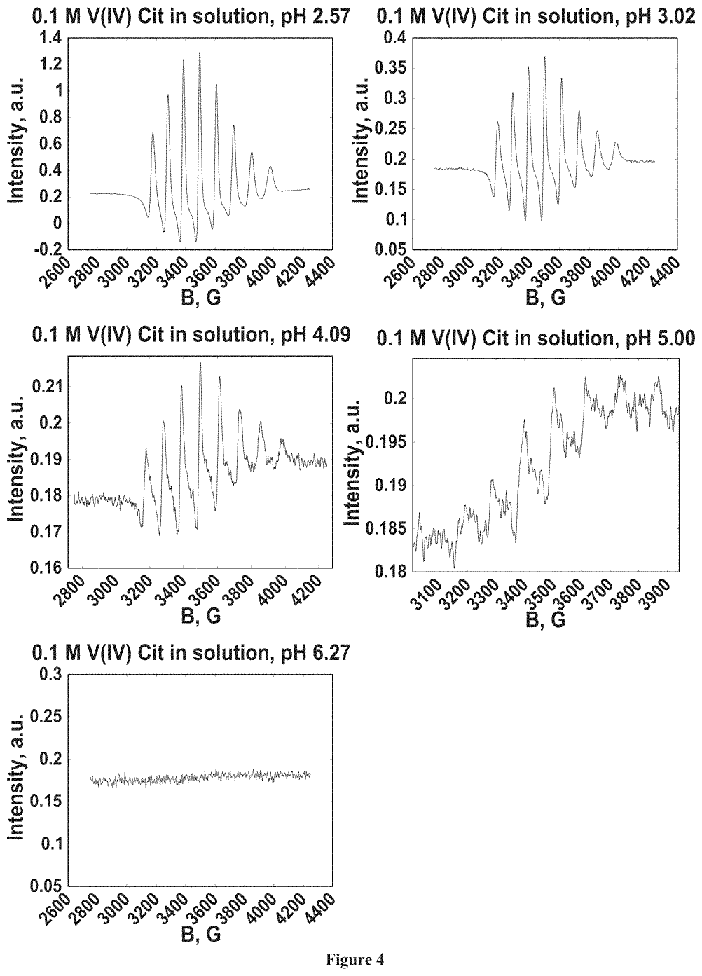

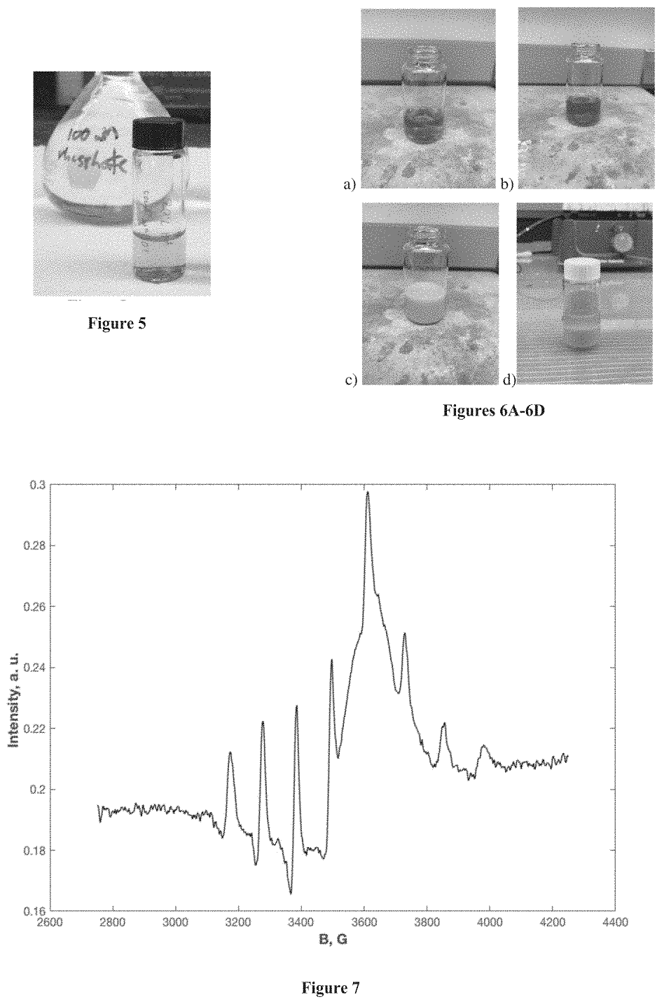

Preparation of the vanadyl sulfate added a phosphate butter VOSO₄-phosphate (CDOS137, HM): To a 0.1 M VOSO₄ solution (0.0235 g, 0.100 mmol in 1.00 mL water), 216 μL of a 1 M phosphate buffer (0.216 mmol) was added in 20 μL aliquots, FIG. 5. The pH of the resulting solution was at 7.01. The solution was stored under argon at 4° C. until further use. Yield: 100%. Final concentration: 82.3 mM. Final volume: 1.22 mL.

Preparation of V^{IV} (Phosphate) in Solution (CDOS137)—Molecular formula: [(V^{IV}O)₂(HPO₄)₂] or alternative—Na₂[(V^{IV}O)₂(PO₄)₂]. Molecular weight: [(V^{IV}O)₂(HPO₄)₂](MW 325.75 g/mol) (2V—101.8828, 10O—159.9000, 2H—2.0156, 2P—61.9476). Alternative: Na₂[(V^{IV}O)₂(PO₄)₂] with MW 369.71 g/mol (2V—101.8828, 10O—159.9000, 2Na—45.9796, 2P—61.9476). Color: Light blue. pH: solution was adjusted to pH 5.81. Compound are presumably a dimer with a loss of two waters not included in presumed formula. EPR spectra showed no signal of samples with ratios 1:2 and 1:3 of V^{IV}:Phosphate (data not shown).

Preparation: To a 0.2 M solution of VOSO₄ (0.235 g, mmol in 5.00 mL DDI water), 5.00 mL of 0.2 M phosphate buffer at pH 7.4 was added dropwise, FIGS. 6A-6D. The buffer (pH 7.4) was prepared by using a Sigma Aldrich buffer reference: Na₂HPO₄ (2.920 g, MW=358.22 g/mol) and NaH₂PO₄ (0.262 g, MW=138.01 g/mol) were dissolved in 50.0 mL DDI water, resulting in a 0.2 M buffer solution. Yield: 100%. The EPR spectrum is shown in FIG. 7: g(1)=1.957, g(2)=1.991, A(1)=404 Hz, A(2)=103 Hz.

Solid Vanadium(V)-Citrates

The section below describes new preparations of V-citrate complexes. Aqueous chemistry of coordination complexes is very pH dependent and often the success of a reaction is dependent on the pH it was carried out under.

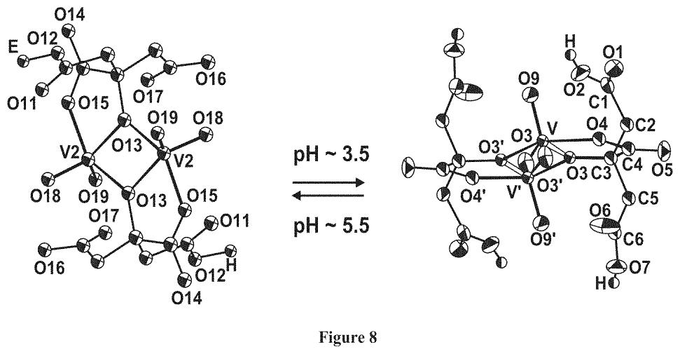

Background: FIG. 8 shows pH-dependent interconversions of K₄[V₂O₄(C₆H₅O₇)₂].5.6H₂O (1) to K₂[V₂O₄(C₆H₆O₇)₂].4H₂O (2). Description of vanadium-citrates (using here H₄C₆H₅O₇ which is abbreviated elsewhere as H₃Cit). Interconversions of the two possible V(V)-citrate complexes is described by Kaliva et al. Inorg. Chem. 2002, 41, 3850-3858. (a) K₄[V₂O₄(C₆H₅O₇)₂].5.6H₂O (1). A quantity of complex 1 (0.95 g, 1.19 mmol) was placed in a 25 mL round-bottom flask and dissolved in 4 mL of water. The pH of the solution was adjusted with dilute hydrochloric acid to pH 3.5, and the resulting solution was stirred for approximately 30 min. The color of the solution turned light green and stayed as such. Subsequently, the reaction mixture was placed in the refrigerator. A few days later, light greenish crystals appeared at the bottom of the flask. The crystals were isolated by filtration and dried in vacuo. The yield was 0.74 g (89.6%). The FT-IR spectrum of the crystalline material was identical to that of an authentic sample of K₂[V₂O₄(C₆H₆O₇)₂]. 4H₂O.

The inventors have developed alternative methods for preparing vanadium(V)-citrate complexes from NaVO₃, a starting material not previously reported. These materials will differ among other characteristics with regard to the pH of the solution when redissolved. Presented below are a number of different preparations.

V(V):Citrate Ratios 1:1

pH 9/7 1:1 V(V):Citrate complex (0.114 M): Using the method by Kaliva et al. Inorg. Chem. 2002, 41, 3850-3858 a complex, K₄[V₂O₄(C₆H₅O₇)₂].5.6H₂O (1) was prepared, where K⁺ has been replaced by Na⁺. VCl₃ (0.090 g, 0.57 mmol) and anhydrous citric acid (0.11 g, 0.57 mmol) were placed in a flask and dissolved in 5 mL of H₂O. To the resulting reaction mixture was added 0.10 M KOH dropwise with stirring, until the color of the solution became dark green and the pH was 9. Subsequently, the reaction mixture was stirred overnight. On the following day, the solution was blue, and the pH was 7. The reaction mixture was taken to dryness by means of a rotary evaporator, and the residue was redissolved in 3 mL of water. The flask was placed in an ice bath, and to it was added H₂O₂ 30% (0.19 mL, 1.84 mmol) dropwise with continuous stirring. The color of the reaction mixture became orange, and stirring was continued for an additional 35 min. Subsequently, ethanol was added, and the flask was placed in the refrigerator. A week later, yellow crystalline material precipitated, which was isolated by filtration and dried in vacuo. Yield: 0.16 g (69.9%). Anal. Calcd for 1, K₄[V₂O₄(C₆H₅O₇)₂].5.6H₂O (C₁₂H_{21.20}O_{23.60}K₄V₂, MW=801.37): C, 17.97; H, 2.64; K, 19.47. Found: C, 17.43; H, 2.61; K, 18.99.

pH 7.4 1:1 V(V):Citrate (0.5 M). NaVO₃ (1.23 g, 10.0 mmol) was added to 10 mL DDI H₂O and boiled at 95° C. until fully dissolved. Once dissolved, citric acid monohydrate (2.11 g, 10.0 mmol), dissolved in 10 mL DDI H₂O, was added to the colorless vanadate solution, resulting in a deep red solution. The pH was adjusted to pH 7.39 using 6 M NaOH and allowed to stir for 15 minutes. After, the volume was reduced by half, methanol added, and placed in a 4° C. refrigerator overnight. Yellow crystals were gathered via vacuum filtration and dried extensively over high vacuum. Yield: 56.2% NMR: ¹H NMR (400 MHz, D₂O) δ 2.72, 2.69, 2.60, 2.57, 2.56, 2.53, 2.47, 2.43. ⁵¹V NMR (105.2 MHz, D₂O) δ −546.75, −575.50, −583.90.

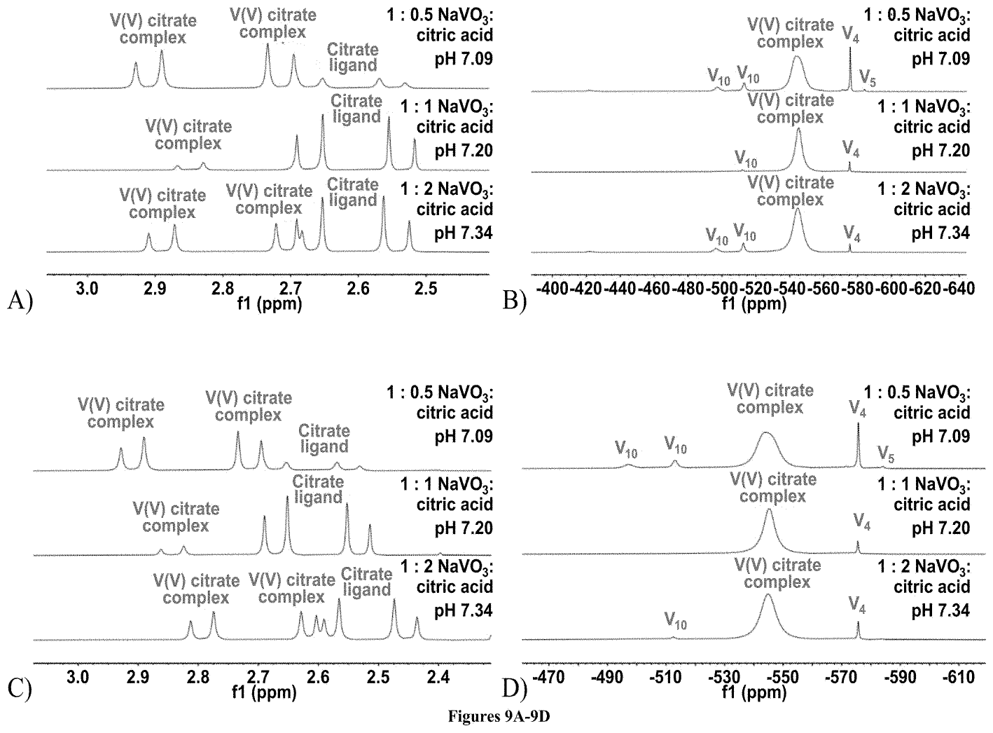

pH 7 1:0.5/1:1/1:2 V(V) Citrate (varying conc). A series of V(V) citrate reactions on a 1 mmol scale was carried out by using the following ratios of NaVO₃ and citric acid: 1 to 0.5, 1 to 1, and 1 to 2. Appropriate amounts of a 0.112 M sodium vanadate stock solution in D₂O and citric acid in D₂O were used in the syntheses. The reaction pH was adjusted to 7 by using 6M NaOD. All reactions mixtures were stirred for 2 hours at ambient temperature. 2.0 mL aliquots of all 3 reaction mixtures were also heated at 50° C. for 5 minutes. All reaction mixtures were analyzed by using ¹H and ⁵¹V NMR, and the results are shown in FIGS. 9A-9D. The experiment was carried out the stoichiometries of citrate species that form in the reaction mixture.

The data shows that the stoichiometries of the species that form in both non-heated and heated solutions remain the same, although there is some peak broadening observed in ⁵¹V NMR, suggesting the formation of more V^{V}Cit isomers.

V(V):Citrate Ratios 1:2

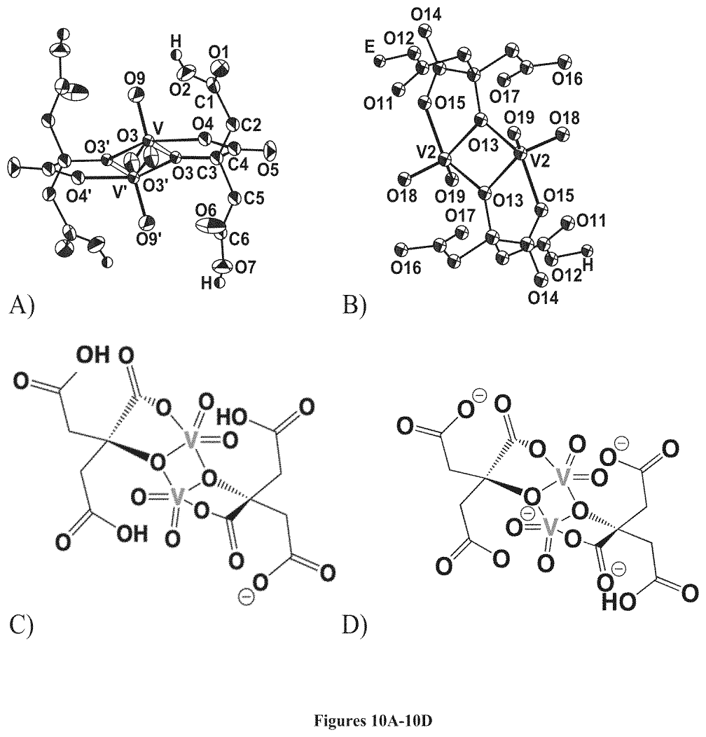

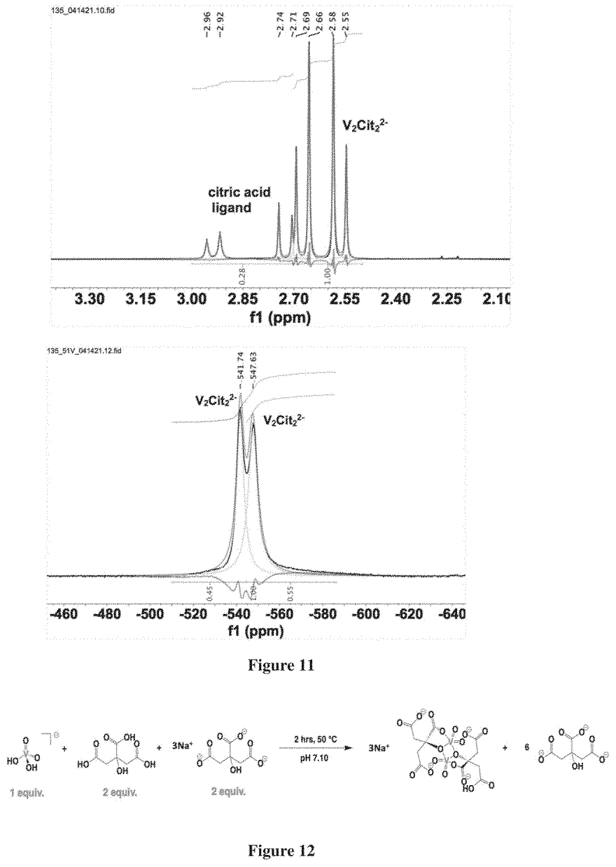

Basic pH 1:2 V(V):citrate (33 mM). Preparation of the vanadium(V) complex (Na₂[VO₂(C₆H₆O₇)]₂.2H₂O). CDOS140 (see FIGS. 10A-10B and FIG. 11) was prepared as reported for K₂[VO₂(C₆H₆O₇)]₂.2H₂O which was described previously by Djordjevic et al. Inorg. Chem. 1989, 28, 719-723. The procedure was modified to prepare the Na⁺ salt instead.

The adjusted procedure is as follows: V₂O₅ (0.103 g, 0.500 mmol) was dissolved as an aqueous solution (10 mL) of NaOH (0.060 g 1.5 mmol) at 40° C. The colorless, clear solution was cooled on ice, and citric acid (0.42 g, 2.0 mM) dissolved in water (5 mL) was added dropwise. The reaction mixture was left in the ice bath until the pale green precipitate settled. It was filtered, washed with ethanol as described above, and dried over drierite. Previously we recorded a yield: ˜50% for the K-salt. Similar yields were observed for the Na⁺-salt. Later reports suggest that the species formed is a 2:2 vanadium(V)-citrate species. Yield: 59.4%. ¹H NMR (D₂O with DSS reference, 400 MHz): δ 2.62 (dd, 4H). ⁵¹V NMR (D₂O, 105.2 MHz): δ −542, −548 ppm. FT-IR: ν 3,339.17 (OH stretch), 1580.05 (C═C stretch), 1398.14, 1355.76 (O—H bend of 3′ alcohol), 1256.40, 1071.67 (C—O stretch), 931.81 (V═O stretch), 867.55 (C—H bend) cm⁻¹.

pH 7.25 1:2 V:Citrate (Conc 80.6 mM). NaVO₃ (0.153 g, 1.25 mmol) was dissolved in 10 mL DDI water and heated at 50° C. for 10 minutes to ensure the dissolution of the solid. This was followed by the addition of aqueous solutions of H₃ citric acid (0.469 g, 2.23 mmol in 2.5 mL DDI water) and sodium citrate (Na₃cit) (0.569 g, 2.20 mmol in 3 mL DDI water) (see FIG. 12). The pH of the reaction mixture was initially 4.53 and adjusted to 7.25 by the dropwise addition of 6 M NaOH. The reaction mixture was allowed to stir for 2 hours at 50° C. in air, and then vacuum filtered. The volume of the reaction mixture was reduced down to 5 mL in vacuo to which 3 mL of methanol was added. The reaction mixture was stored at −20° C. for 24 hours. Yield: 84.5%: ¹H NMR (400 MHz, D₂O): δ 2.60 (dd, 4H). ⁵¹V NMR (105.2 MHz, D₂O): δ −545 ppm.

pH 7.20 1:1:1 V(V) Citrate Reaction (56 mM): NaVO₃ (1.13 mmol, 0.138 g) was added to 10 mL of DDI H₂O and stirred at 95° C. until fully dissolved. Sodium citrate (0.296 g, 1.02 mmol) and citric acid (1.04 mmol, 0.218 g) were dissolved in 10 mL DDI H₂O and added to NaVO₃ solution, resulting in an orange solution with a pH of 4.66. The pH was adjusted to 7.20 using 6 M NaOH and allowed to stir for two hours. Afterwards, the solution was reduced in volume to ˜5 mL, and methanol added to the solution. The solution was placed in a −20° C. freezer over the weekend, in which bright yellow crystals were obtained. These crystals were isolated by vacuum filtration and dried thoroughly on high vacuum. Yield: 67.5% NMR: ¹H NMR (400 MHz, D₂O) δ 2.73, 2.70, 2.60, 2.58, 2.56, 2.54, 2.47, 2.43. ⁵¹V NMR (105 MHz, D₂O) δ −545.50, −570.70, −575.60, −583.90. pH 7.0 Buffered 1:2 V(V) Citrate (27 mM): NaVO₃ (0.55 mmol, 0.068 g) was added to 10 mL of DDI H₂O and boiled at 95° C. until fully dissolved. Once fully dissolved, sodium citrate (0.323 g, 1.10 mmol) and citric acid (4.0 mg, 0.019 mmol) were dissolved in 10 mL DDI H₂O and added to the NaVO₃ solution, resulting in a faint yellow solution and the pH adjusted to 6.92 using 6 M HCl. The solution was allowed to stir for two hours at room temperature, and the volume was subsequently reduced to −5 mL. Methanol was added to the solution and let sit at 4° C. over the weekend. Yellow crystals were collected via vacuum filtration and thoroughly dried over high vacuum. Yield: 89.5% NMR: ¹H NMR (400 MHz, D₂O) δ 2.59, 2.56, 2.47, 2.43. ⁵¹V NMR (105 MHz, D₂O) δ −545.60, −570.20, −575.50.

pH 7 Buffered 1:2 V(V) Citrate reaction (28 mM): NaVO₃ (1.12 mmol, 0.138 g) was added to 10 mL of DDI H₂O and boiled at 95° C. until fully dissolved. Once fully dissolved, 20 mL of a 100 mmol (2 mmoles) pH 7 buffered citrate solution was added, resulting in a faint yellow mixture. The mixture was allowed to stir for 15 minutes at room temperature, at which point the solution was concentrated to approximately 5 mL, methanol was added, and placed into a 4° C. refrigerator overnight. Bright yellow crystals formed overnight, Yield: 85.6%. NMR: ¹H NMR (400 MHz, D₂O) δ 2.60, 2.56, 2.47, 2.43. ⁵¹V NMR (105 MHz, D₂O) δ −545.40, −570.90, −575.50, −583.90. pH 7.25 Reaction 1:2 Vanadium: Citrate (33 mM). To a pH 6.98 buffered 22 mL citrate solution (0.558 g, 2.15 mmol), 11 mL of a NaVO₃ solution (0.136 g, 1.10 mmol) was added, resulting in a faint yellow solution with a pH of 7.75. The solution was allowed to stir at ambient temperature for two hours, at which point the solution had a pH of 7.25. The solution was reduced in volume to 5 mL which resulting in an oily yellow liquid. Methanol was added to the solution until turbidity persisted and placed at −20° C. and allowed to crystallize over the weekend. The compound oiled out of solution.

pH 6.92 V ratios 1:1:1 V(V) Citrate (77 mM). NaVO₃ (0.140 g, 1.15 mmol) was dissolved in 10 mL of DDI H₂O, and heated to 50° C. to ensure complete dissolution of the solid, then the flask was cooled to ambient temperature. Citric acid (0.257 g, 1.13 mmol) and sodium citrate (0.578 g, 1.12 mmol) were dissolved in 5 mL of DDI H₂O and added dropwise to the solution, resulting in a yellow solution with a pH of 4.66. The pH of was adjusted to 6.92 using 6 M NaOH. The solution was stirred 50° C. for two hours, at which point the volume was reduced to 5 mL under vacuum. Methanol was added and allowed to crystallize at 4° C. overnight. Vibrant yellow crystals were collected via filtration the next day. The solid was dried extensively under high vacuum. Yield: 82.3% (⁵¹V NMR shows the presence of complex and oxovanadates).

pH 6.62 1:2 Vanadium: Citrate (33 mM). To a pH 6.52 buffered 20 mL citrate solution (0.307 g, 1.99 mmol), a 10 mL NaVO₃ solution (0.121 g, 1.00 mmol) was added, resulting in a faint yellow solution with a pH of 6.91. The solution was allowed to stir at ambient temperature for two hours, at which point the solution had a pH of 6.62 was reduced in volume to 5 mL, resulting in an oily yellow liquid. Methanol was added to the solution until turbidity persisted and placed at −20° C. and allowed to crystallize over the weekend. The compound oiled out of solution.

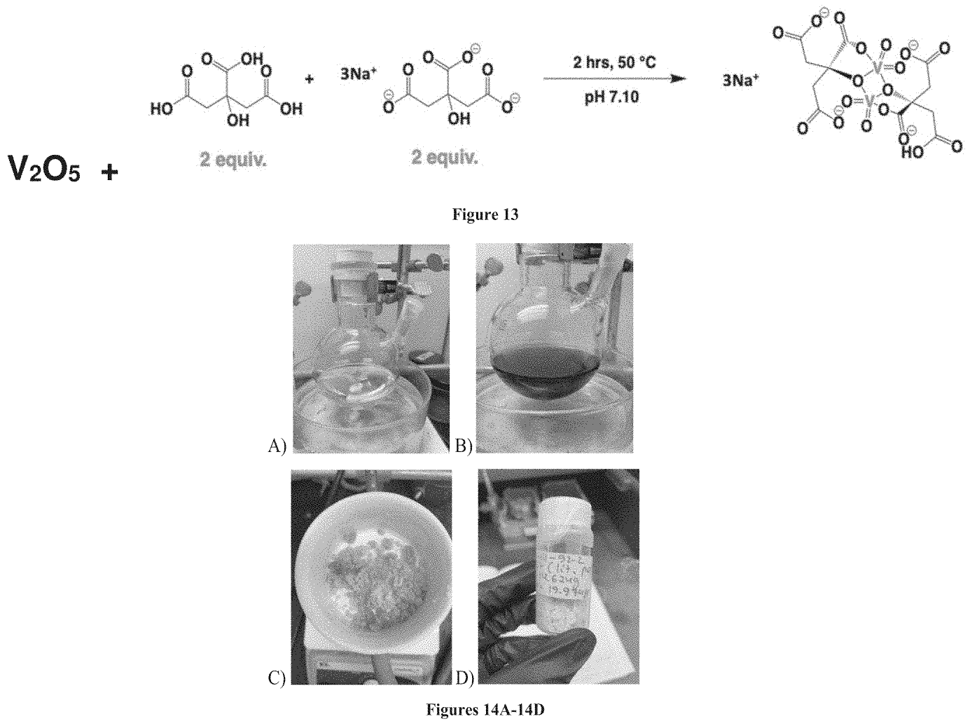

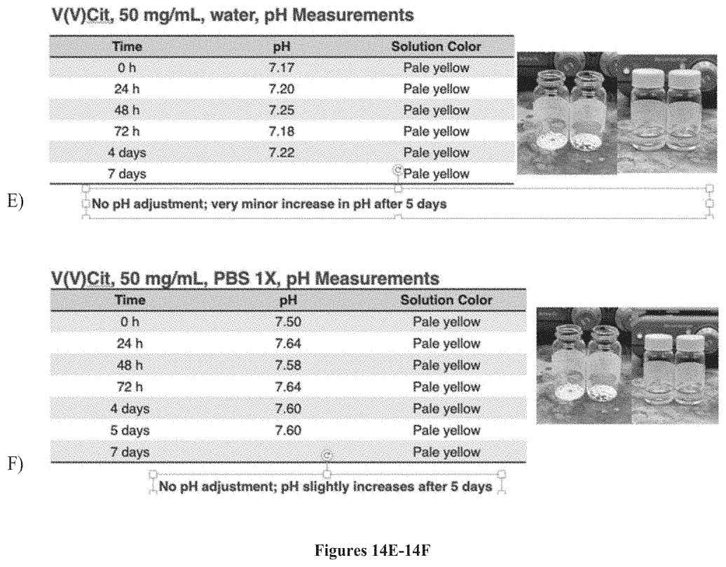

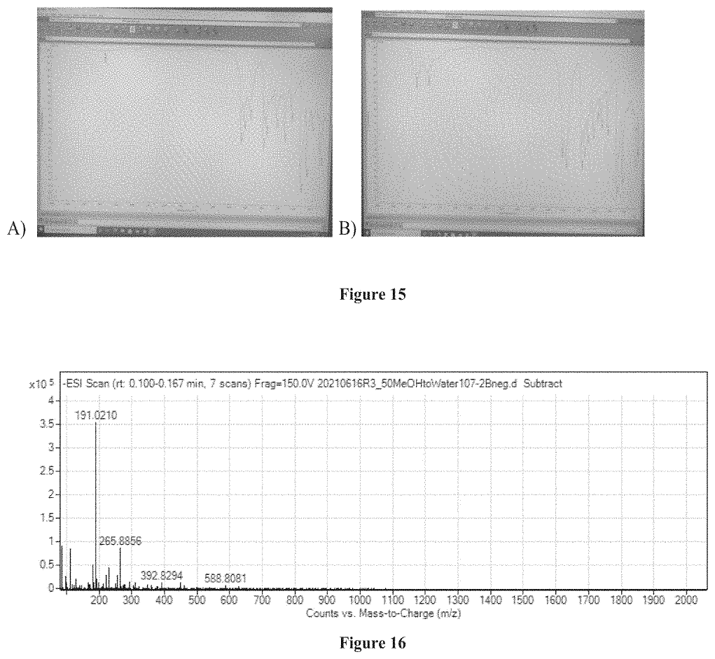

An inventive procedure which involves scaling up (10× scale-up) to prepare Vanadium Citrate for pre-clinical studies is provided (FIGS. 13-14): V₂O₅ (2.00 g, 11.0 mmol) was placed in 60.0 mL of DDI water, followed by the addition of KOH (2.50 g, 44.6 mmol) with continuous stirring. The slurry was stirred for 15 minutes with heating until V₂O₅ was dissolved and the solution turned clear. The solution was cooled for 30 minutes, followed by the addition of anhydrous citric acid (8.00 g, 41.6 mmol). Following dissolution of the tricarboxylic acid, the pH was adjusted to 5.5 with 50.0 mL of 1.0 M KOH, and the color of the solution turned yellow-green. Stirring was continued for an additional 1 h at 50° C., and the color of the reaction mixture stayed the same. Subsequently, 80.0 mL of ethanol was added, and the reaction flask was placed at 4° C. for 48 h. A couple of days later, yellow crystals appeared at the bottom of the flask. The crystalline material was isolated by filtration and dried in vacuo. Yield: 79.4% ¹H (D₂O, 400.3 MHz): 2.73 (dd, 4H), 2.91 (dd, 0.75H), 3.00 (dd, 1H). ⁵¹V (D₂O, 105.2 MHz): −525, −541, −548 ppm. FT-IR: \tilde{ν} 3333 (O—H stretch of ROOH), \tilde{ν} 2940 (sp³ C—H stretch), \tilde{ν} 1683 (C═O stretch), \tilde{ν} 1595 (C═C stretch), 1393, (O—H bend of ROOH), 1365 (O—H bend of 3′ OH), \tilde{ν} 1147, 1070 (C—O stretch), \tilde{ν}935 (V═O stretch), \tilde{ν} 862 (C—H bend) FIG. 15. Elemental analysis: C—20.87%, H—2.31%, N<0.05% (suggests the formula K₃[(VO₂)₂(C₆H₆O₇)(C₆H₅O₇)]×3 H₂O). m/z: [(M⁺2Na⁺H)⁻], Calculated: 588.9217, found: 588.8081 (FIG. 16).

V(V):Citrate ratios 1:3

pH 7.22 Reaction 1:3 Vanadium: Citrate (25 mM). To a pH 6.98 buffered 33 mL citrate solution (0.499 g, 3.23 mmol), a 11 mL NaVO₃ solution (0.134 g, 1.10 mmol) was added, resulting in a faint yellow solution with a pH of 7.47. The solution was allowed to stir at ambient temperature for two hours, at which point the solution had a pH of 7.22, was reduced in volume to 5 mL, resulting in an oily yellow liquid. Methanol was added to the solution until turbidity persisted and placed at −20° C. and allowed to crystallize over the weekend. The compound oiled out of solution.

pH 6.59 1:3 Vanadium: Citrate (24 mM). To 31 mL of a pH 6.52 buffered citrate solution (0.797 g, 3.09 mmol), 10 mL of a NaVO₃ solution (0.122 g, 1.00 mmol) was added, resulting in a faint yellow solution with a pH of 6.72. The solution was allowed to stir at ambient temperature for two hours, at which point the solution had a pH of 6.59, was reduced in volume to 5 mL, resulting in an oily yellow liquid. Methanol was added to the solution until turbidity persisted and placed at −20° C. and allowed to crystallize over the weekend, resulting in vibrant yellow crystals. ⁵¹V NMR showed the presence of oxovanadate particularly tetravanadate in solution upon dissolution of the solid. Yield: 88.4%. NMR: ¹H NMR (400 MHz, D₂O) δ 2.58 (dd, J=31.3, 14.7 Hz, 4H). ⁵¹V NMR (105.2 MHz, D₂O) δ −546, −550, −570 (V₂), −576 (V₄), −584 (V₅).

pH 6.5 1:3 Vanadium:Citrate Preparation (24 mM). To 31 mL of a pH 6.52 buffered citrate solution (0.801 g, 3.09 mmol), a 10 mL NaVO₃ solution (0.123 g, 1.00 mmol) was added, resulting in a faint yellow solution with a pH of 6.72. The solution was allowed to stir at ambient temperature for two hours, at which point the solution had a pH of 6.59. The volume was reduced to 5 mL, resulting in an oily yellow liquid. Methanol was added to the solution until turbidity persisted and placed at −20° C. and allowed to crystallize over the weekend, resulting in vibrant yellow crystals. The presence of oxovanadates with tetramer as most prominent was observed by ⁵¹V NMR. Yield: 88.4% NMR: ¹H NMR (400 MHz, D₂O) δ 2.58 (dd, J=31.3, 14.7 Hz, 4H). ⁵¹V NMR (105.2 MHz, D₂O) δ −546, −550, −570 (V₂), −576 (V₄), −584 (V₅).

V(V):Citrate Ratios 1:4

pH 8 V ratios 1:4 V(V):citrate (conc 70.0 mM). NaVO₃ (0.137 g, 1.12 mmol) was dissolved in 10.0 mL DDI water and heated at 50° C. for 10 minutes to ensure the dissolution of the solid. This was followed by the addition of an aqueous solution of sodium citrate (1.156 g, 4.42 mmol in 6.00 mL DDI water). The pH of the reaction mixture was adjusted to 8 by the dropwise addition of 6 M HCl. The reaction mixture was stirred for 2 hours at 50° C. The volume of the reaction mixture was reduced down to 5 mL in vacuo. The filtrate was vacuum filtered to which isopropanol was added to recrystallize the final product at −20° C. Yield: 33.3%. ¹H NMR (400 MHz, D₂O): 2.60 (dd). ⁵¹V NMR (105.2 MHz, D₂O): −545 ppm.

pH 71:4 V:Citrate (Conc 74.7 mM). NaVO₃ (0.137 g, 1.12 mmol) was dissolved in 10.0 mL DDI water and heated at 50° C. for 10 minutes to ensure the dissolution of the solid. This was followed by the addition of an aqueous solution of citric acid (0.929 g, 4.42 mmol in 5.00 mL DDI water). The pH of the reaction mixture was adjusted to 7 by the dropwise addition of 6 M NaOH. The reaction mixture was stirred for 2 hours at 50° C. The volume of the reaction mixture was reduced down to 5 mL in vacuo. The filtrate was vacuum filtered to which isopropanol or methanol was added to recrystallize the final product at −20° C. Yield: 74.9% (crystallization in methanol). ¹H NMR (400 MHz, D₂O): 2.58 (dd). ⁵¹V NMR (105.2 MHz, D₂O): −545 ppm.

pH 71:2:2 V:Citrate (Conc 80.6 mM). NaVO₃ (0.153 g, 1.25 mmol) was dissolved in 10.0 mL DDI water and heated at 50° C. for 10 minutes to ensure the dissolution of the solid. This was followed by the addition of aqueous solutions of citric acid (0.469 g, 2.23 mmol in 2.50 mL DDI water) and sodium citrate (0.569 g, 2.20 mmol in 3.00 mL DDI water). The pH of the reaction mixture was adjusted to 7 by the dropwise addition of 6 M NaOH. The reaction mixture was stirred for 2 hours at 50° C. The volume of the reaction mixture was reduced down to 5 mL in vacuo. The filtrate was vacuum filtered to which isopropanol or methanol was added to recrystallize the final product at −20° C. Reaction scheme shown in FIG. 12. Yield 84.5% (crystallization in methanol). ¹H NMR (400 MHz, D₂O): 2.60 (dd). ⁵¹V NMR (105.2 MHz, D₂O): −545 ppm.

pH 71:4 V:Citrate (70.0 mM). NaVO₃ (0.137 g, 1.12 mmol) was dissolved in 10.0 mL DDI water and heated at 50° C. for 10 minutes to ensure the dissolution of the solid. This was followed by the addition of an aqueous solution of sodium citrate (1.156 g, 4.42 mmol in 6.00 mL DDI water). The pH of the reaction mixture was adjusted to 7 by the dropwise addition of 6 M HCl. The reaction mixture was stirred for 2 hours at 50° C. The volume of the reaction mixture was reduced down to 5 mL in vacuo. The filtrate was vacuum filtered to which isopropanol was added to recrystallize the final product at −20° C. Yield: 60.0%. ¹H NMR (400 MHz, D₂O): 2.60 (dd). ⁵¹V NMR (105.2 MHz, D₂O): −545 ppm.

pH 71:4 V:Citrate ratios (220 mM). A number of reactions were ran using a 1:4 ratio of V:citrate where NaVO₃ (1.341 g, 11 mmol) was dissolved (pH 7) and the solution was added 4 eq citrate buffer as describe in the table (corresponding to 44 mmol) citrate. The yellow solution was stirred for 15 min after which the volume is reduced to about 50 mL. After adding methanol or ethyl acetate and left for crystallization. As shown below after isolating the crystals and drying the yield varies from 0% to 73%. In these reactions the scale of the preparation was increased by a factor of 10-20, demonstrating that the reaction is scalable with variable yields.

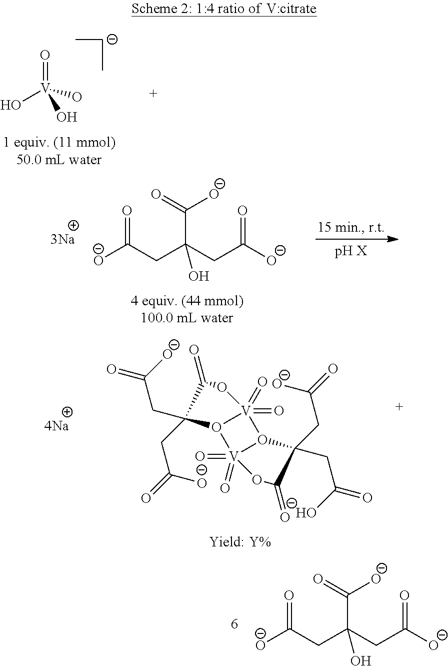

General Procedure Vanadate:citrate=1:4 (CDOS146), pH 7, methanol. Sodium metavanadate (1.34 g, 11.0 mmol) was dissolved in 50.0 mL DDI water and let to stir at 90° C. for 5 minutes until the solid is fully dissolved. 0.440 M citrate buffer at pH 6 was then added (100.0 mL, 44 mmol), and the reaction mixture was let to stir for 15 minutes at r. t. The volume was reduced by ⅔ in vacuo. Methanol was then added to the mixture, and it was let to crystallize at −20° C. for 2 days. Yield: 134%. Final pH=6.67 (pH range from 6.7-7.2 in repeat preparations). Yield indicates that the precipitate contains some of the excess citrate ligand since complex is assigned to the 2:2 species.

TABLE 1
A pH 7 series of reactions of NaVO₃ with citrate

| | | Crystal- | |
|---|---|---|---|
| | | lization | |
| | pH | solvent | Yield |
| 1:4 V:citrate (buf) | 7.10 | Methanol | 73% (4.476 g) |
| 1:4 V:citrate (buf) | 7.69 | Methanol | 27% (1.635 g) |
| 1:4 V:citrate (buf) | 7.00 | Ethyl | — |
| | | acetate | |
| 1:4 (solid citrate added to | 7.00 | Methanol | 58% (3.560 g) |
| RT NaVO₃ | | | |
| 1:4 (citrate buffer added | 7.10 | Methanol | 0% |
| to hot NaVO₃) | | | |
| 1:4 (citrate buffer at 60° C.) | 7.69 | Methanol | — |
| 1:4 (citrate buffer) | 7.0 ± 0.1 | Methanol | 134% (9.331 g)* |
| | repeated | | CDOS146 |
| 1:4 (citrate buffer at 60° C.) | 7.0 ± 0.1 | Methanol | 125% (8.700 g)* |
| | (repeated) | | |
| 1:4 (citrate buffer) | 7.0 ± 0.1 | Methanol | 154% (10.724g)* |
| | (repeated) | | CDOS148 |
| 1:4 (citrate buffer at 60° C.) | 7.00 | Methanol | — |

*indicate precipitate contains some of the excess citrate ligand since complex is assigned to the 2:2 species

pH 71:4 V:Citrate ratios (73 mM) (CDOS146). NaVO₃ (1.341 g, 11 mmol) was dissolved in 50.0 mL DDI water and let to stir at 90° C. for 5 minutes until the solid is fully dissolved. 0.440 M citrate buffer at pH 6 was then added (100.0 mL, 44 mmol), resulting in a final pH of 6.67, and the reaction mixture was let to stir for 15 minutes at r. t. The volume was reduced by ⅔ in vacuo. Methanol was then added to the mixture, and it was let to crystallize at −20° C. for X days. Yield: 134%. ¹H NMR (D₂O, 400 MHz): δ 2.60 (dd, 4H). ⁵¹V NMR (D₂O, 105.2 MHz): δ −545 ppm. Yield indicates that the precipitate contains some of the excess citrate ligand since complex is assigned to the 2:2 species. pH 71:4 V:Citrate ratios (73 mM) (CDOS147). NaVO₃ (1.341 g, 11 mmol) was dissolved in 50.0 mL DDI water and let to stir at 90° C. for 5 minutes until the solid is fully dissolved. 0.440 M citrate buffer at pH 6 was then added (100.0 mL, 44 mmol), resulting in a final pH of 6.59, and the reaction mixture was let to stir for 15 minutes at 60° C. The volume was reduced by ⅔ in vacuo. Methanol was then added to the mixture, and it was let to crystallize at −20° C. for X days. Yield: 125%. ¹H NMR (D₂O, 400 MHz): δ 2.60 (dd, 4H). ⁵¹V NMR (D₂O, 105.2 MHz): δ −545 ppm. Yield indicates that the precipitate contains some of the excess citrate ligand since complex is assigned to the 2:2 species.

pH 6.95 1:2:2 V(V) Citrate Reaction (56 mM): NaVO₃ (1.12 mmol, 0.136 g) was added to 10 mL of DDI H₂O and boiled at 95° C. until fully dissolved. Once fully dissolved, citric acid monohydrate (2.25 mmol, 0.476 g) and sodium citrate dihydrate (2.24 mmol, 0.659 g) dissolved in 10 mL of DDI H₂O was added, resulting in a yellow solution. The pH of the mixture was adjusted to pH 6.96 using 6 M NaOH and was allowed to stir open to air for 15 minutes, at which point the solution was reduced in volume to approximately 5 mL, methanol added, and let sit at 4° C. Bright yellow crystals formed after 24 hrs. Yield: 52.0%. NMR: ¹H NMR (400 MHz, D₂O) δ 2.59, 2.56, 2.47, 2.43. ⁵¹V NMR (105 MHz, D₂O) δ −511.50, −545.70, −570.50 (V₂), −575.60 (V₄), −584.00 (V₅).

pH 6.92 1:2:2 V(V) (77 mM). Sodium metavanadate (0.140 g, 1.15 mmol) was dissolved in 10 mL of DDI H₂O and heated to 50° C. to ensure complete dissolution of the solid, then the flask was cooled to ambient temperature. Citric acid (0.257 g, 1.13 mmol) and sodium citrate (0.578 g, 1.12 mmol) were dissolved in 5 mL of DDI H₂O and added dropwise to the solution, resulting in a yellow solution with a pH of 4.66. The pH of was adjusted to 6.92 using 6 M NaOH. The solution was stirred 50° C. for two hours, at which point the volume was reduced to 5 mL under vacuum. Methanol was added and allowed to crystallize at 4° C. overnight. Vibrant yellow crystals were collected via filtration the next day. The solid was dried extensively under high vacuum. Yield: 82.3%. ¹H NMR (400 MHz, D₂O) δ 2.58 (dd, J=30.3, 14.9 Hz, 4H). ⁵¹V NMR (105 MHz, D₂O) δ −545, −554 (V₁), −571 (V₂), −575 (V₄).

pH 6.95 1:2:2 V(V) Citrate Reaction (56 mM): NaVO₃ (1.12 mmol, 0.137 g) was added to 10 mL of DDI H₂O and boiled at 95° C. until fully dissolved. Once fully dissolved, citric acid monohydrate (2.24 mmol, 0.472 g) and sodium citrate dihydrate (2.24 mmol, 0.658 g) dissolved in 10 mL of DDI H₂O was added to the colorless vanadate solution, resulting in a yellow solution. The pH of the mixture was adjusted to pH 6.95 using 6 M NaOH, and was allowed to stir open to air for 2 hours, at which point the solution was reduced in volume to approximately 5 mL, methanol added, and let sit at 4° C. Bright yellow crystals formed after 24 hrs. Yield: 35.7% NMR: ¹H NMR (400 MHz, D₂O) a 2.58 (dd, J=30.3, 14.9 Hz, 4H). ⁵¹V NMR (105 MHz, D₂O) δ −545.00, −571.10 (V₂), −575.50 (V₄), −583.90 (V₅).

pH 6.95 1:2:2 V(V) Citrate Reaction (56 mM): NaVO₃ (1.12 mmol, 0.137 g) was added to 10 mL of DDI H₂O and boiled at 95° C. until fully dissolved. Once fully dissolved, citric acid monohydrate (0.476 g, 2.26 mmol) and sodium citrate dihydrate (2.25 mmol, 0.662 g) dissolved in 10 mL of DDI H₂O was added, resulting in a yellow solution. The pH of the mixture was adjusted to pH 6.95 using 6 M NaOH, and was allowed to stir open to air for 2 hours, at which point the solution was reduced in volume to approximately 5 mL, methanol added, and let sit at 4° C. Bright yellow crystals formed after 24 hrs. Yield: 89.6%. NMR: ¹H NMR (400 MHz, D₂O) δ δ 2.58 (dd, J=30.3, 14.9 Hz, 4H). ⁵¹V NMR (105 MHz, D₂O) δ −545.90, −570.50 (V₂), −575.40 (V₄).

pH 6.92 1:2:2 V(V) Citrate Reaction (57 mM): NaVO₃ (0.140 g, 1.15 mmol) was dissolved in 10 mL of DDI H2O and heated to 50° C. to ensure complete dissolution of the solid, then the flask was cooled to ambient temperature. Citric acid monohydrate (0.471 g, 2.24 mmol) and sodium citrate dihydrate (0.663 g, 2.25 mmol) were dissolved in 5 mL of DDI H₂O and added dropwise to the solution, resulting in a yellow solution with a pH of 4.36. The pH of was adjusted to 6.92 using 6 M NaOH. The solution was stirred 50° C. for two hours, at which point the volume was reduced to 5 mL under vacuum. Methanol was added and allowed to crystallize at 4° C. overnight. Yellow crystals were collected via filtration the next day. The solid was dried extensively under high vacuum. Yield: 89.2% ¹H NMR (400 MHz, D₂O) δ 6 2.58 (dd, J=30.3, 14.9 Hz, 4H). ⁵¹V NMR (105 MHz, D₂O) δ −512.10, −545.20, −575.50 (V₄).

Vanadium(IV) Citrates

V(IV)-citrates in the literature were generally prepared from VCl₃, which is an expensive and less reliable precursor than VOSO₄. There is one report using VOSO₄ in basic solution (pH 8). This pH adjustment is not appropriate since V(IV) is not stable at neutral and basic pH values.

pH 8 V:Citrate ratios 1:4 (220 mM). A sample of VCl₃ (0.18 g, 1.1 mmol) and anhydrous citric acid (0.924 g, 4.40 mmol) were mixed in water (5 mL). The pH of the reaction mixture was adjusted to near 8 with an aqueous solution of 0.4 M NaOH and stirring continued overnight. On the following day, the blue solution was taken to dryness. The residue was redissolved in 2 mL of ddi-H₂O, and 2-propanol was added. Within 2 days, blue crystals formed at 4° C., which were isolated by filtration and dried in vacuo. The yield was 0.20 g (89%). Anal. Calcd for K₄V₂C₁₂H₂₀O₂₂: C, 18.60; H, 2.58; K, 20.14. Found: C, 18.67; H, 2.53; K, 19.90.

Inventive Methods for V (V)-Citrates

pH4.5 1:1 V(IV):citrate (73.3 mM). VOSO₄ (0.261 g, 1.11 mmol) was dissolved in 10.0 mL DDI to which 5.00 mL of an aqueous solution of citric acid (0.233 g, 1.11 mmol) was added dropwise. The pH of the reaction mixture was adjusted to 4.5 by the dropwise addition of 6 M NaOH. The reaction mixture was stirred for 2 hours at 50° C. The volume of the reaction mixture was then reduced in half, followed by the addition of 3 mL of isopropanol. The resulting solution was allowed to crystallize at −20° C. for 24 hours. Yield: 54.4%.

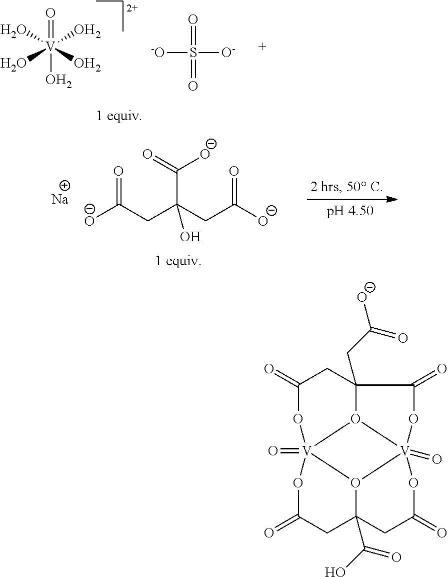

pH4.5 1:2 V(IV):citrate (73.3 mM). VOSO₄ (0.261 g, 1.11 mmol) was dissolved in 10.0 mL DDI to which 5.00 mL of an aqueous solution of citric acid (0.233 g, 1.11 mmol) was added dropwise. The pH of the reaction mixture was adjusted to 4.5 by the dropwise addition of 6 M NaOH. The reaction mixture was stirred for 2 hours at 50° C. The volume of the reaction mixture was then reduced in half, followed by the addition of X mL of isopropanol. The resulting solution was allowed to crystallize at −20° C. for 24 hours. Yield: 47.2%. Spin Hamiltonian parameters: N/A.

pH4.5 1:4 V(IV):citrate (73.3 mM). VOSO₄ (0.261 g, 1.11 mmol) was dissolved in 10.0 mL DDI to which 5.00 mL of an aqueous solution of citric acid (0.233 g, 1.11 mmol) was added dropwise. The pH of the reaction mixture was adjusted to 4.5 by the dropwise addition of 6 M NaOH. The reaction mixture was stirred for 2 hours at 50° C. The volume of the reaction mixture was then reduced in half, followed by the addition of X mL of isopropanol. The resulting solution was allowed to crystallize at −20° C. for 24 hours. Yield: 0%. Spin Hamiltonian parameters: N/A.

pH4.5 1:4 V(IV):citrate (73.3 mM). VOSO₄ (0.261 g, 1.11 mmol) was dissolved in 10 mL DDI water and sonicated for 30 seconds to ensure the dissolution of the solid. To this solution, 5 mL of an aqueous solution of citric acid (0.233 g, 1.11 mmol) was added dropwise. The reaction mixture was prepared in triplicate, and the pH of the reaction mixture was adjusted to 4.5 by the dropwise addition of 6 M NaOH. The reaction mixture was allowed to stir for 2 hours in air at 40° C. The volume of the reaction mixture was then reduced in half, followed by the addition of 3 mL of isopropanol to each mixture. The resulting solution was allowed to crystallize at −20° C. for 24 hours. Yield 54.4%.

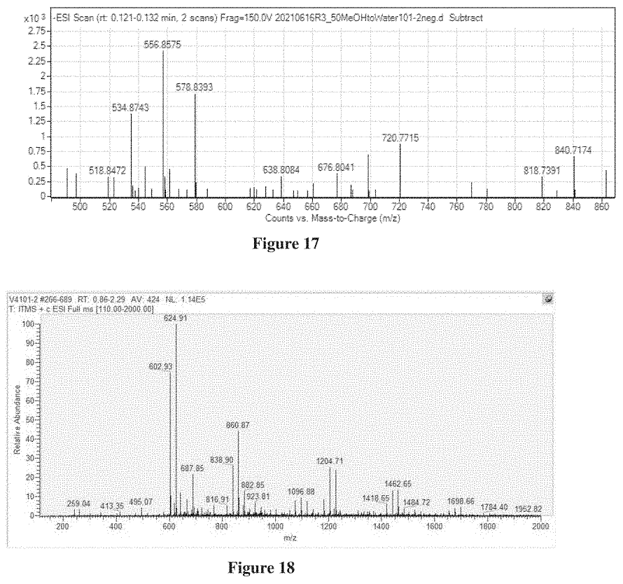

CDOS155 Vanadium(IV) citrate, FIG. 12-13, 2:2 vanadate:citrate—Formula: Na₃[(V^{IV}O)₂(C₆H₄O₇)(C₆H₅O₇)] different preparations with varying amounts of crystal waters. Molecular Weight: anion 510.8, however calculating with 3Na⁺ 579.89 g/mol (no crystal H₂O) g/mol and 705.93 g/mol w (w Na+ and w. 7 crystal H₂O's). m/z: [(M+2Na)⁺] Calculated: 556.89440, found: 556.8575 (FIG. 17).

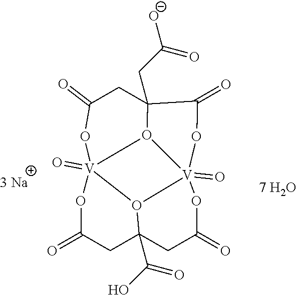

Color: dark blue; Solubility: soluble in water; Color in solution: light blue

General Procedure: A VOSO₄ aqueous solution (1.18 g, 5.00 mmol in 50.0 mL DDI water) was prepared to which 20 mL of an aqueous solution of citric acid (1.05 g, 5.00 mmol)/sodium citrate (1.47 g, 5.00 mmol) was added. The pH of the reaction mixture was adjusted to 4.50 by the dropwise addition of 6 M NaOH. The reaction mixture was allowed to stir for 2 hours at an ambient temperature. It was then vacuum filtered, and its volume was reduced in half in vacuo. Acetone (30 mL) was added to the reaction mixture, and the product was allowed to crystallize at −20° C. for 24 hours. Yield: 80.6%. ¹H NMR, EPR (10.0 mM solution in water): g(1)=1.940, g(2)=2.036, A(1)=397 MHz, A(2)=44 MHz. FT-IR: \tilde{ν} 3330 cm⁻¹ (O—H stretch of ROOH), \tilde{ν} 2940 cm⁻¹ (sp³ C—H stretch), \tilde{ν} 1600 cm⁻¹ (C═C stretch), \tilde{ν} 1410 cm⁻¹ (O—H bend of ROOH), 1360 cm⁻¹ (O—H bend of 3′ OH), \tilde{ν} 1240 cm⁻¹, 1200 cm⁻¹, 1160 cm⁻¹, 1120 cm⁻¹, 1110 cm⁻¹ (C—O stretch), \tilde{ν} 967, 924 cm⁻¹ (V═0 stretch). Elemental Analysis, Mass Spec: m/z 602.93 (corresponds to Na₃[(V^{IV}O)₂(C₆H₄O₇)(C₆H₅O₇)]) (see FIG. 18).

Syntheses of V(IV) Cit on a 5 Mmol Scale at Both Room and Elevated Temperatures

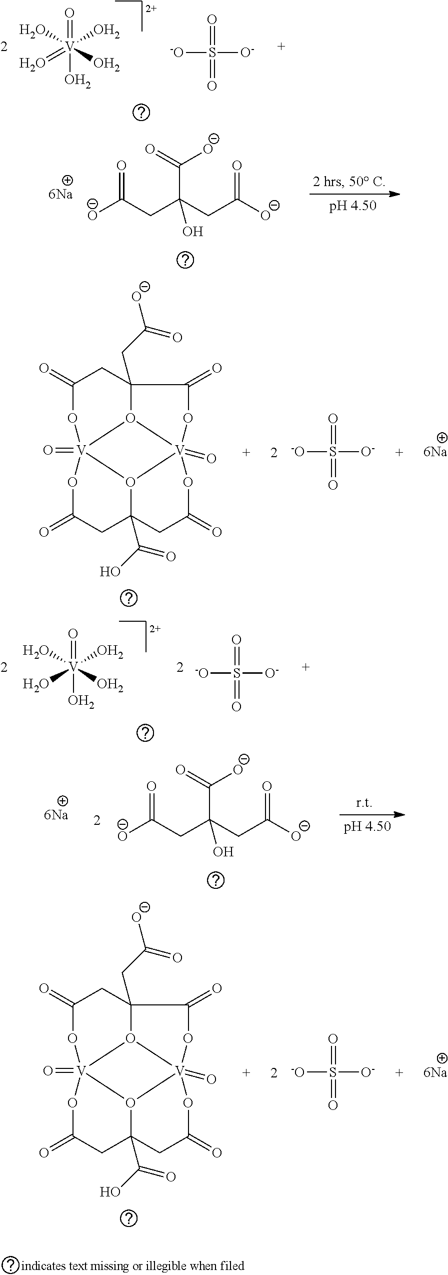

VOSO₄:citric acid=1:1, pH 4.50, 50° C., isopropanol: A VOSO₄ aqueous solution (1.18 g, 5.00 mmol in 50.0 mL DDI water) was prepared to which 15.0 mL of an aqueous solution of citric acid (1.05 g, 5.00 mmol). The pH of the reaction mixture was adjusted to 4.50 by the dropwise addition of 6 M NaOH. The reaction mixture was allowed to stir for 2 hours at 50° C. It was then vacuum filtered, and its volume was reduced in half in vacuo. Isopropanol (3 mL) was added to the reaction mixture, and the product was allowed to crystallize at −20° C. for 24 hours. Yield: 1.522 g/74.4%. Solution pH=4.52

VOSO₄:citric acid=1:1, pH 4.50, 50° C., methanol: A VOSO₄ aqueous solution (1.18 g, 5.00 mmol in 50.0 mL DDI water) was prepared to which 15.0 mL of an aqueous solution of citric acid (1.05 g, 5.00 mmol). The pH of the reaction mixture was adjusted to 4.50 by the dropwise addition of 6 M NaOH. The reaction mixture was allowed to stir for 2 hours at 50° C. It was then vacuum filtered, and its volume was reduced in half in vacuo. Methanol (3 mL) was added to the reaction mixture, and the product was allowed to crystallize at −20° C. for 24 hours. Yield: 0.862 g/42.2%. Solution pH=4.71.

VOSO₄:citric acid=1:1, pH 4.50, room temperature, isopropanol: A VOSO₄ aqueous solution (1.18 g, 5.00 mmol in 50.0 mL DDI water) was prepared to which 15.0 mL of an aqueous solution of citric acid (1.05 g, 5.00 mmol). The pH of the reaction mixture was adjusted to 4.50 by the dropwise addition of 6 M NaOH. The reaction mixture was allowed to stir for 24 hours at an ambient temperature. It was then vacuum filtered, and its volume was reduced in half in vacuo. Isopropanol (3 mL) was added to the reaction mixture, and the product was allowed to crystallize at −20° C. for 24 hours. Yield: 2.045 g/100%. Solution pH=4.84

VOSO₄:citric acid=1:1, pH 4.50, room temperature, methanol: A VOSO₄ aqueous solution (1.18 g, 5.00 mmol in 50.0 mL DDI water) was prepared to which 15.0 mL of an aqueous solution of citric acid (1.05 g, 5.00 mmol). The pH of the reaction mixture was adjusted to 4.50 by the dropwise addition of 6 M NaOH. The reaction mixture was allowed to stir for 24 hours at an ambient temperature. It was then vacuum filtered, and its volume was reduced in half in vacuo. Methanol (3 mL) was added to the reaction mixture, and the product was allowed to crystallize at −20° C. for 24 hours. Yield: 0.902 g/44.1%. Solution pH=4.84.

VOSO₄:citric acid=1:1, pH 4.50, room temperature, acetone: A VOSO₄ aqueous solution (1.18 g, 5.00 mmol in 50.0 mL DDI water) was prepared to which 15.0 mL of an aqueous solution of citric acid (1.05 g, 5.00 mmol). The pH of the reaction mixture was adjusted to 4.50 by the dropwise addition of 6 M NaOH. The reaction mixture was allowed to stir for 24 hours at an ambient temperature. It was then vacuum filtered, and its volume was reduced in half in vacuo. Acetone (3 mL) was added to the reaction mixture, and the product was allowed to crystallize at −20° C. for 24 hours. Yield: 1.943 g/95.0%. Solution pH=4.44.

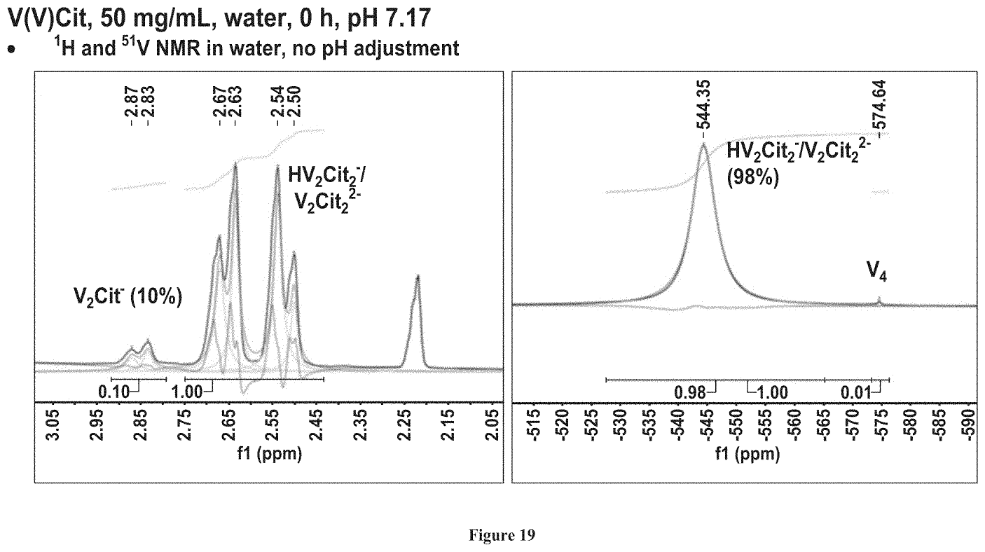

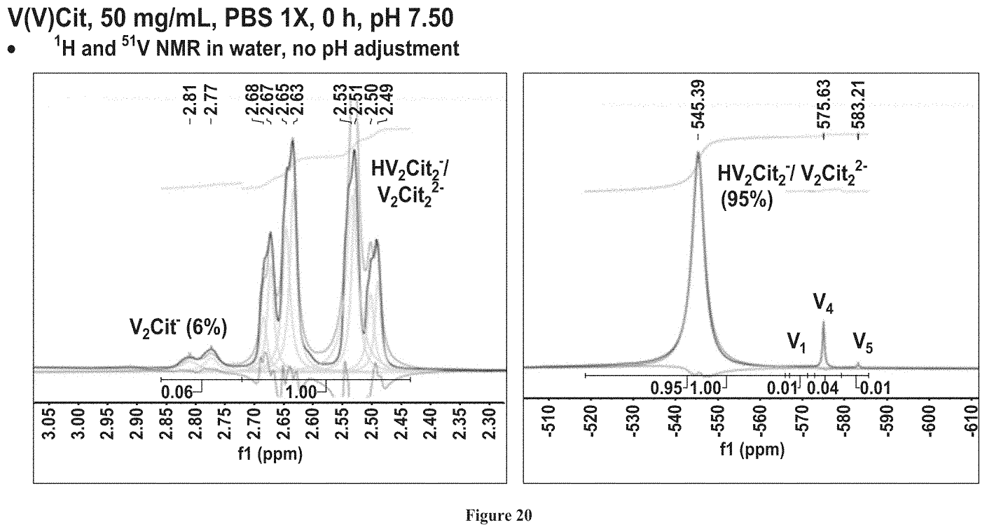

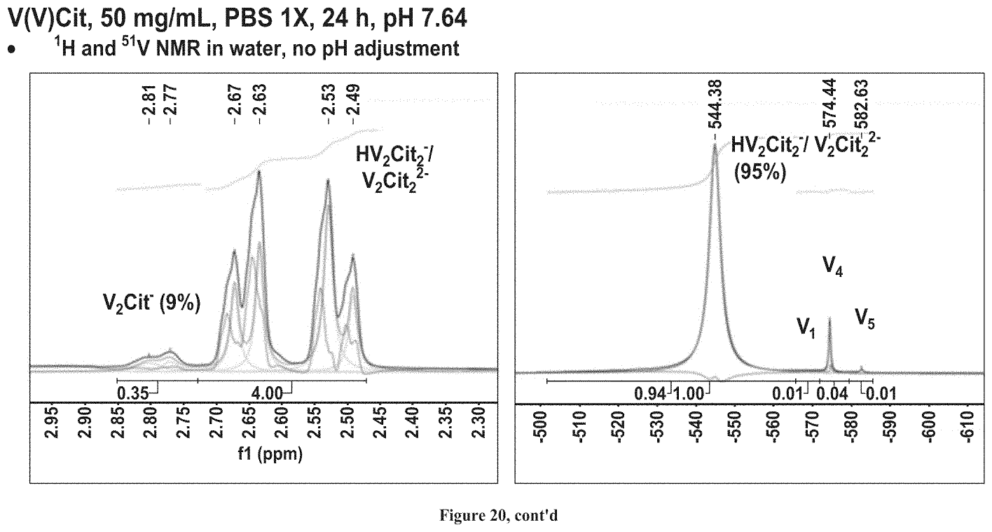

Solubility and stability of vanadium complexes. An amount of CDOS150 solid was dissolved into water and phosphate buffered saline (PBS) buffer to determine its solubility and stability of the vanadium-citrate complexes (See FIGS. 19 and 20). The CDOS150 solid dissolved up to pH 5. The pH was adjusted to pH 7.4 by adding a base. The stability of CDOS150 was measured both in water and in PBS-buffer; the solutions did require initial pH adjustment.

An amount of CDOS155 solid was mixed with PBS buffer to determine its solubility. The CDOS155 solid dissolved up to pH 5. The pH was adjusted to pH 7.4 by adding a base. The stability of CDOS155 was limited at pH 7.4 but similar in water or PBS but required continuous pH adjustment.

An amount of CDOS146 solid was mixed with PBS buffer to determine its solubility. The CDOS146 solid dissolved up to pH 7.2 to 7.4. The stability of CDOS146 was similar in water or PBS and did not require pH adjustment.

Other advantages which are obvious and which are inherent to the invention will be evident to one skilled in the art. For example, these materials must show a high stability, and the pH upon sample dissolution is important to their properties; representative data is shown in FIGS. 19 and 20. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

1. A method for preparing a composition comprising a vanadium(IV) complex, the method comprising,
reacting a mixture comprising an aqueous solution of vanadyl(IV) sulfate (VOSO₄) and a buffer selected from a citrate buffer or a phosphate buffer,
wherein the mixture has a mole ratio of VOSO₄ to citrate or phosphate of 1:0.5 to 1:10, and
wherein the reaction is carried out at a pH of 9 or less, 7.5 or less, or from 6 to 7.5.

2. A method for preparing a composition comprising a vanadium(IV) complex, the method comprising,
reacting a mixture comprising an aqueous solution of vanadyl(IV) sulfate (VOSO₄) and citric acid or phosphoric acid,
wherein the mixture has a mole ratio of VOSO₄ to citric acid or phosphoric acid of 1:0.5 to 1:10, and
wherein the reaction is carried out at a pH of 7.5 or less, 5.5 or less, or from 4 to 5.5.

3. The method of claim 1, wherein the vanadium(IV) complex is a vanadium(IV) citrate complex comprising vanadium(IV) and citrate in a mole ratio of 1:1 to 1:4, such as 1:1, 1:2, 1:3, or 1:4.

4. The method of claim 1, wherein the vanadium(IV) complex is a vanadium(IV) phosphate complex comprising vanadium(IV) and phosphate in a mole ratio of 1:1 to 1:4, such as 1:1, 1:2, 1:3, or 1:4.

5. The method of claim 1, wherein the vanadium (IV) complex is selected from Na₄[V₂O₂(C₆H₄O₇)₂] (CDOS139); K₂[V^{IV}₂O₄(C₆H₆O₇)₂]; K₄[V^{IV}₂O₂(C₆H₄O₇)₂]; Na₃[(V^{IV}O)₂(C₆H₄O₇)(C₆H₅O₇)] (CDOS136); (K₃[(V^{IV}O)₂(C₆H₄O₇)(C₆H₅O₇)]); (NH₄)₄[V₂O₂(C₆H₄O₇)₂]; or [(V^{IV}O)₂(HPO₄)₂] (or Na₂[(V^{IV}O)₂(PO₄)₂]; CDOS137), wherein each complex optionally has one or more water hydrate.

6. The method of claim 1, wherein the buffer has a pH from 5.5 to 7.5, or from 6 to 7.

7. The method of claim 1, wherein the buffer is a citrate buffer comprising citric acid and sodium citrate.

8. The method of claim 1, wherein the buffer, citric acid, or phosphoric acid is present in the mixture at a concentration of 1.5 M or less, such as 0.02 M to 1.2 M.

9. The method of claim 1, wherein the VOSO₄ is present in the mixture at a concentration of 1.5 M or less, such as 0.02 M to 1.2 M.

10. The method of claim 1, wherein the mole ratio of VOSO₄ to citrate, phosphate, citric acid or phosphoric acid in the mixture is 1:1 to 1:10, 1:1 to 1:5, or 1:1 to 1:4.

11. The method of claim 1, wherein the buffer, citric acid, or phosphoric acid is added incrementally.

12. The method of claim 1, further comprising heating the mixture to a temperature of 70° C. or less, such as from 40° C. to 60° C.

13. The method of claim 1, further comprising adding a polar organic solvent to the mixture to induce crystallization of the vanadium(IV) complex.

14. The method of claim 13, wherein the polar organic solvent is selected from methanol, isopropanol, acetone, ethyl acetate, ether, acetonitrile, or a combination thereof.

15. The method of claim 1, wherein the reaction provides a yield for the vanadium(IV) complex of at least 50% by weight, or at least 70% by weight.

16. The method of claim 1, wherein the composition comprises at least 30% by mass vanadium(IV) complex.

17. A method for preparing a composition comprising vanadium (V) citrate complex, the method comprising,
reacting in a mixture an aqueous solution of a metavanadate (VO₃³⁻) or orthovanadate (VO₄³⁻) compound and a citrate compound selected from citric acid, a citrate salt, a citrate buffer, or a combination thereof;
wherein the metavanadate or orthovanadate compound and the citrate compound are in a mole ratio of 1:0.5 to 1:10,
wherein the reaction is carried out at a pH of 9 or less, 7.5 or less, or from 6 to 7.5.

18-30. (canceled)

31. A method for preparing a composition comprising vanadium(V) citrate complex, the method comprising,
adding citric acid to a basic solution of V₂O₅ compound and allowing the citric acid and V₂O₅ compound to react at a temperature of 60° C. or less and a pH of less than 8, less than 7, or from 4.5 to 7.5,
wherein the method produces vanadium(V) citrate complex at a concentration of 10 mM or greater.

32-42. (canceled)
